(19) United States
(12) Patent Application Publication
(10) Pub. No.: US 2010/0208581 A1
(43) Pub. Date: Aug. 19, 2010

(54) DATA TRANSFER SYSTEM, DATA TRANSMITTING DEVICE, DATA RECEIVING DEVICE AND DATA TRANSFER METHOD

(75) Inventors: Tomohiro NAGANO, Kawasaki (JP); Kazumi Hayasaka, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/703,967

(22) Filed: Feb. 11, 2010

(30) Foreign Application Priority Data
Feb. 13, 2009 (JP) 2009-31267

(51) Int. Cl. H04L 12/26

(52) U.S. Cl. 370/217

(57) ABSTRACT

A data transfer system includes a transmitting device and a receiving device. The transmitting device includes a selecting unit selecting a data body to be transmitted, a transmitting unit dividing the data body and sending the data body to the plurality of signal lines, an alternative-signal-line transmitting unit sending the control data to an alternative signal line, and a signal-line selecting unit connecting the alternative signal line to an output terminal of the transmitting unit or an output terminal of the alternative signal line transmitting unit. When one of the signal lines fails, the transmission selecting unit connects the alternative signal line to the output terminal of the transmitting unit. The receiving device includes reception signal-line selecting units, each reception signal-line selecting unit selects a corresponding signal line and the alternative signal line, the receiving unit assembling the divided data body, and an alternative-signal-line receiving unit receiving the control data.

### CROSS-REFERENCE TO RELATED APPLICATION

This application is based upon and claims priority to prior Japanese Patent Application No. 2009-31267 filed on Feb. 13, 2009 in the Japan Patent Office, the entire contents of which are incorporated herein by reference.

### FIELD

Embodiments discussed herein relate to data transfer systems, data transmitting devices, data receiving devices and data transfer methods.

### BACKGROUND

Japanese Unexamined Patent Application Publication No. 2007-116443 discloses a technology for transmission of a control packet for control data. In the disclosed technology, the control packet is transmitted through only two of a plurality of lines constituting multi-links, and normal data packets are distributed for transmission through any of the lines other than the two lines through which the control packets are transmitted.

Japanese Unexamined Patent Application Publication No. 2006-186527 discloses a technology in which a failed channel is identified during data transmission and is electrically disconnected. Once the failed channel is electrically disconnected only channels that are working properly are alternatively used to reconfigure data transfer to allow transmission.

[Patent Document 1] Japanese Laid-Open Patent Publication No. 2007-116443

[Patent Document 2] Japanese Laid-Open Patent Publication No. 2006-186527

### SUMMARY

According to an aspect of an invention, a data transfer system includes a data transmitting device and a data receiving device. The data transmitting device includes a transmission-data selecting unit selecting a data body to be transmitted, a transmitting unit dividing the data body and sending the divided data body to the plurality of signal lines, an alternative-signal-line transmitting unit sending the control data to an alternative signal line, and a transmission signal-line selecting unit connecting the alternative signal line to one of an output terminal of the transmitting unit and an output terminal of the alternative signal line transmitting unit. When one of the plurality of signal lines fails, the transmission selecting unit connects the alternative signal line to the output terminal of the transmitting unit. The data receiving device includes reception signal-line selecting units and an alternative-signal-line receiving unit. Each reception signal-line selecting unit selects a corresponding signal line and/or the alternative signal line. The receiving unit assembles the divided data body. The alternative-signal-line receiving unit receives the control data. The object and advantages of the invention will be realized and achieved by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of an information processing apparatus that serves as a data transfer system according to an embodiment;

FIG. 2 is a diagram illustrating a method for transferring packets between a data transmitting device and a data receiving device in a reference example;

FIG. 3 is a diagram illustrating a method for transferring packets between the data transmitting device and the data receiving device in the reference example;

FIG. 4 is a diagram illustrating a method for transferring packets between the data transmitting device and the data receiving device in the reference example;

FIG. 5 is a diagram illustrating a method for transferring packets between the data transmitting device and the data receiving device in the reference example;

FIG. 6 is a diagram illustrating a method for transferring packets between a data transmitting device and a data receiving device in an embodiment;

FIG. 7 is a diagram illustrating a method for transferring packets between the data transmitting device and the data receiving device in the embodiment;

FIG. 8 is a diagram illustrating a method for transferring packets between the data transmitting device and the data receiving device in the embodiment;

FIG. 9 is a diagram illustrating a method for transferring packets between the data transmitting device and the data receiving device in the embodiment;

FIG. 10 is a diagram illustrating a failure detection method that is applicable to the information processing apparatus in the embodiment;

FIG. 11 is a diagram illustrating a failure detection method that is applicable to the information processing apparatus in the embodiment;

FIG. 12 is a sequence diagram illustrating a flow of an operation for transferring packets between the data transmitting device and the data receiving device in the embodiment;

FIG. 13 is a sequence diagram illustrating a flow of an operation for transferring packets between the data transmitting device and the data receiving device in the embodiment;

FIG. 14 is a diagram illustrating a method for determining the start of packet transfer after the data receiving device performs signal-line switching, the method being applicable to the information processing apparatus in the present embodiment;

FIG. 15 is a sequence diagram illustrating a flow of the operation in the method illustrated in FIG. 14;

FIG. 16 is a diagram illustrating a method for determining the start of packet transfer after the data receiving device performs signal-line switching, the method being applicable to the information processing apparatus in the present embodiment;

FIG. 17 is a sequence diagram illustrating a flow of the operation in the method illustrated in FIG. 16;

FIG. 18 is a diagram illustrating a method for determining the start of packet transfer after the data receiving device performs signal-line switching, the method being applicable to the information processing apparatus in the present embodiment;

FIG. 19 is a sequence diagram illustrating a flow of the operation in the method illustrated in FIG. 18;

FIG. 20 is a diagram illustrating an example of the structure of a packet, the example being applicable to the information processing apparatus in the embodiment;

FIG. 21 is a diagram illustrating an example of the structure of a packet, the example being applicable to the information processing apparatus in the embodiment;

FIG. 22 is a diagram illustrating an example of the structure of a packet, the example being applicable to the information processing apparatus in the embodiment;

FIG. 23 is a diagram illustrating an example of the structure of a packet, the example being applicable to the information processing apparatus in the embodiment; and

FIG. 24 is a diagram illustrating an application example of a delivery acknowledgement packet, the example being applicable to the information processing apparatus in the embodiment.

### DESCRIPTION OF EMBODIMENTS

This embodiment is directed to a data transfer system in which a data transmitting device and a data receiving device are interconnected by multiple signal lines to transfer packets through the multiple signal lines. In the data transfer system, an alternative signal line is prepared. When an abnormality is present in the signal lines, the alternative signal line can be used instead of the abnormal signal line. In the data transfer system, when the signal lines are working properly, a control packet is transmitted through the alternative signal line. To this end, the data transfer system has a configuration described below. The data transmitting device includes a selecting circuit for selecting which one of multiple types of control packets is to be sent to the alternative signal line and a transmitting unit for transmitting the selected control packet to the alternative signal line. The data receiving device includes an alternative-signal-line receiving unit for receiving the control packet that arrives at the data receiving device through the alternative signal line. As described above, according to the present embodiment, when the multiple signal lines are working properly, a control packet is transmitted through the alternative signal. Thus, the packet transfer efficiency can be enhanced when the multiple signal lines are working properly.

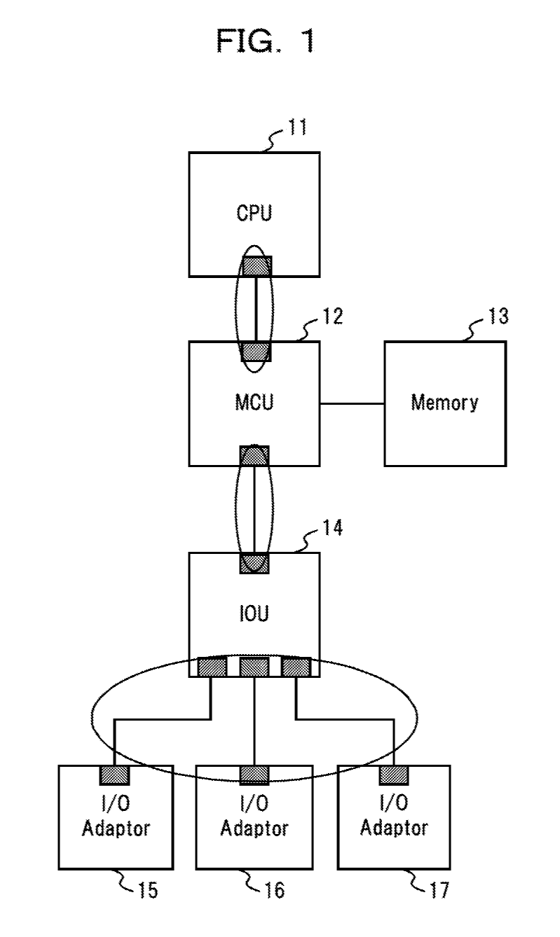

FIG. 1 is a block diagram illustrating an overall configuration of an information processing apparatus that serves as a data transfer system according to the embodiment. The information processing apparatus includes multiple LSIs (Large Scale Integrated circuits), each of which functions as either a data transmitting device or a data receiving device or as both a data transmitting device and a data receiving device.

As illustrated in FIG. 1, the information processing apparatus includes a CPU (Central Processing Unit) 11 serving as an arithmetic processing device and an MCU (Memory Control Unit) 12 serving as a memory control device. The information processing apparatus further includes a memory 13 functioning as a storage device and an IOU (Input Output Unit) 14 and I/O (Input Output) adaptors 15 to 17 functioning as I/O (Input Output) device control devices. Of the elements in the information processing apparatus, the CPU 11, the MCU 12, the IOU 14, and the I/O adaptors 15 to 17 are implemented as LSIs, each of which functions as either a data transmitting device or a data receiving device or both a data transmitting device and a data receiving device.

The CPU 11 performs various types of arithmetic processing and may control the entire information processing apparatus. The memory 13 stores various types of data used when the CPU 11 performs the arithmetic processing and the control, as well as a program for causing the CPU 11 to execute the arithmetic processing and the control. The MCU 12 manages information to be stored by I/O devices, such as a disk drive, externally connected via the memory 13, the IOU 14, and the I/O adaptors 15 to 17. The I/O adaptors 15 to 17 provide interfaces needed to exchange information with the I/O devices externally connected to the information processing apparatus. The IOU 14 centrally manages the I/O devices, externally connected to the information processing apparatus, via the I/O adaptors 15 to 17.

Multiple signal lines and an alternative signal line are used to transfer data between the CPU 11 and the MCU 12, to transfer data between the MCU 12 and the IOU 14, and to transfer data between the IOU 14 and the I/O adaptors 15 to 17. Each of the CPU 11, the MCU 12, the IOU 14, and the I/O adaptors 15 to 17 functions as either a data transmitting device or a data receiving device or both a data transmitting device and a data receiving device. Thus, when each of the CPU 11, the MCU 12, the IOU 14, and the I/O adaptors 15 to 17 function as a data transmitting device, it may be referred to as a “data transmitting device”, and when each of the CPU 11, the MCU 12, the IOU 14, and the IO adaptors 15 to 17 function as a data receiving device, it may be referred to as a “data receiving device”. In addition, each of the CPU 11, the MCU 12, the IOU 14, and the IO adaptors 15 to 17 may be referred to as a “data transmitting device”.

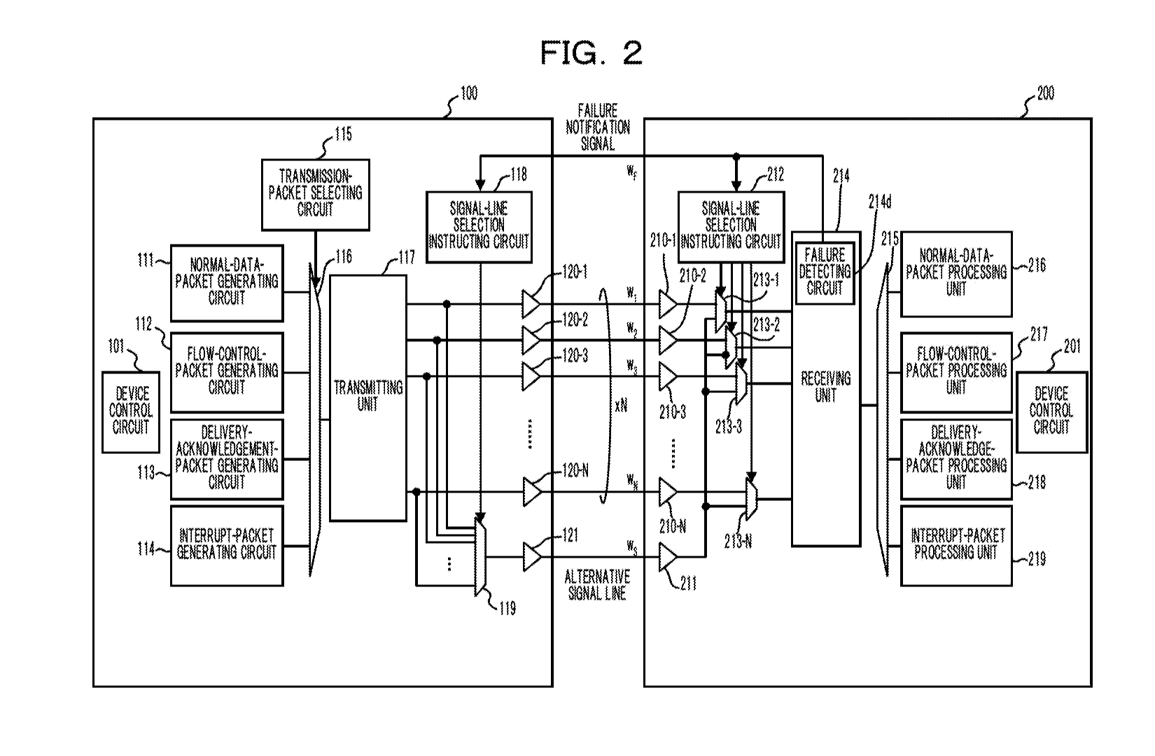

In the information processing apparatus of the embodiment in which multiple signal lines and an alternative signal line are used to transfer data between a data transmitting device and a data receiving device, normal data packets (which are packets containing instructions and so on regarding memory read, memory write, and cache coherency and which are simply referred to as “data packets” hereinafter) are transferred between the data transmitting device and the data receiving device. In addition to the data packets, for example, a packet involving interruption and a flow control packet for controlling transferring packets between the data transmitting device and the data receiving device are transferred between the data transmitting device and the data receiving device. A method for transferring packets between a data transmitting device and a data receiving device according to a reference example will be described below with reference to FIGS. 2 to 5.

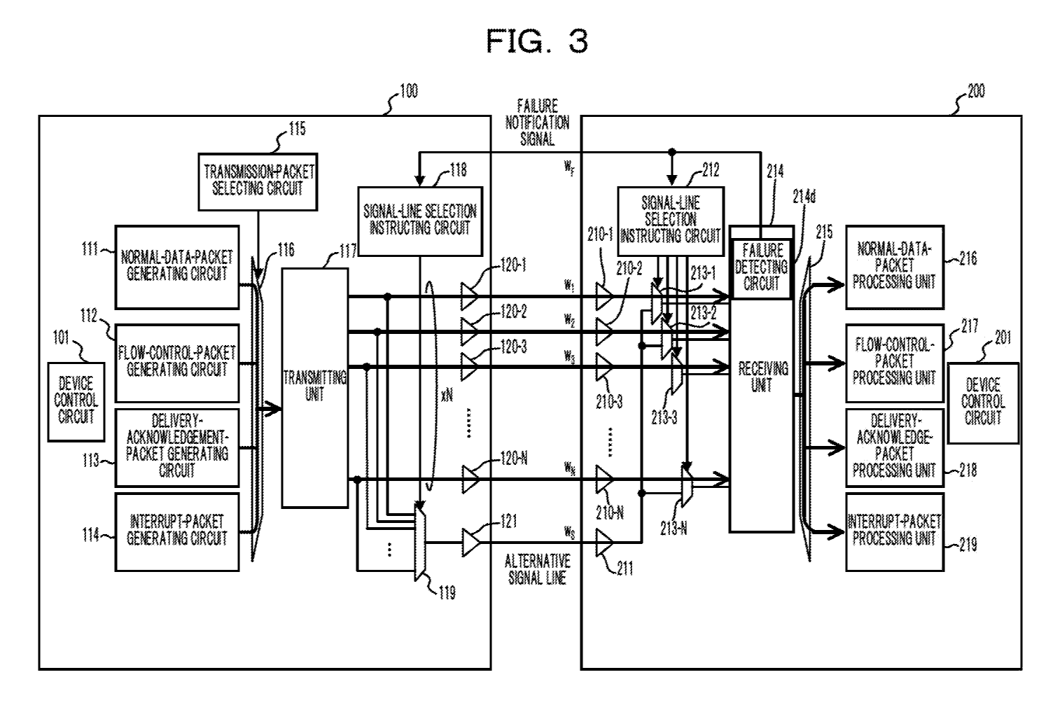

For transferring packets between the data transmitting device and the data receiving device in the reference example, as illustrated in FIG. 3, the signal lines W1 to WN are used to transfer data packets and a control packet between the data transmitting device and the data receiving device when multiple signal lines W1 to WN are working properly. The expression “between the data transmitting device and the data receiving device” as used herein refers to “between a data transmitting device 100 and a data receiving device 200” illustrated in FIGS. 2 to 5. The “control packet” as used herein refers to any of a flow control packet, a delivery acknowledgement packet, and an interrupt packet, for example. The flow control packet, the delivery acknowledgement packet, and the interrupt packet are generated by a flow-control-packet generating circuit 112, a delivery-acknowledgement-packet generating circuit 113, and an interrupt-packet generating circuit 114, respectively, which are described below with reference to FIG. 2.

It is assumed that one of the signal lines W1 to WN fails for some reason. In this case, the failed signal line cannot be used to transfer packets. In this case, an alternative signal line WS is prepared as a signal line for use instead of the failed signal line. Replacing the failed signal line with the alternative signal line WS allows packet transfer to be continued. In the reference example, when none of the signal lines W1 to WN have failed, the alternative signal line WS is not used to transfer packets. That is, in the reference example, the alternative signal line WS is used as a spare line.

A method for transferring packets between the data transmitting device and the data receiving device in the reference example will now be described in detail with reference to FIGS. 2 to 5.

FIG. 2 illustrates sections, included in the data transmitting device 100 and the data receiving device 200, which are related to transfer of packets between the data transmitting device 100 and the data receiving device 200. Sections that are included in the data transmitting device 100 and the data receiving device 200 and that are not related to transfer of packets between the data transmitting device 100 and the data receiving device 200 may have configurations of known LSIs, such as those of a CPU and MCU, and detailed descriptions thereof are not given hereinafter.

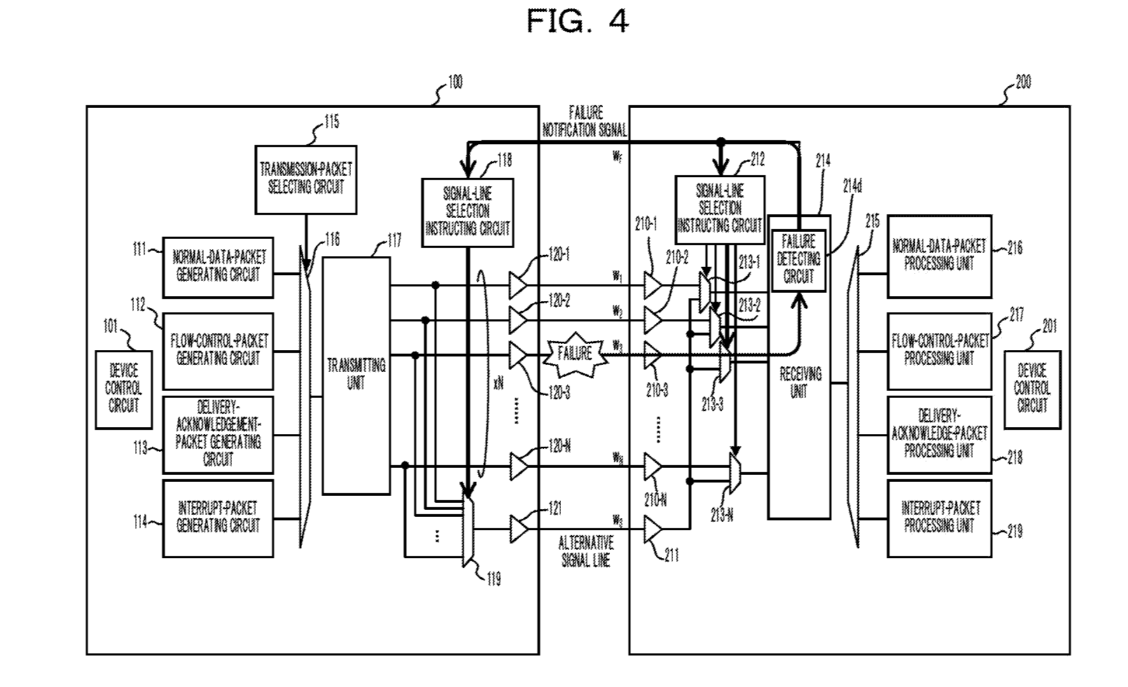

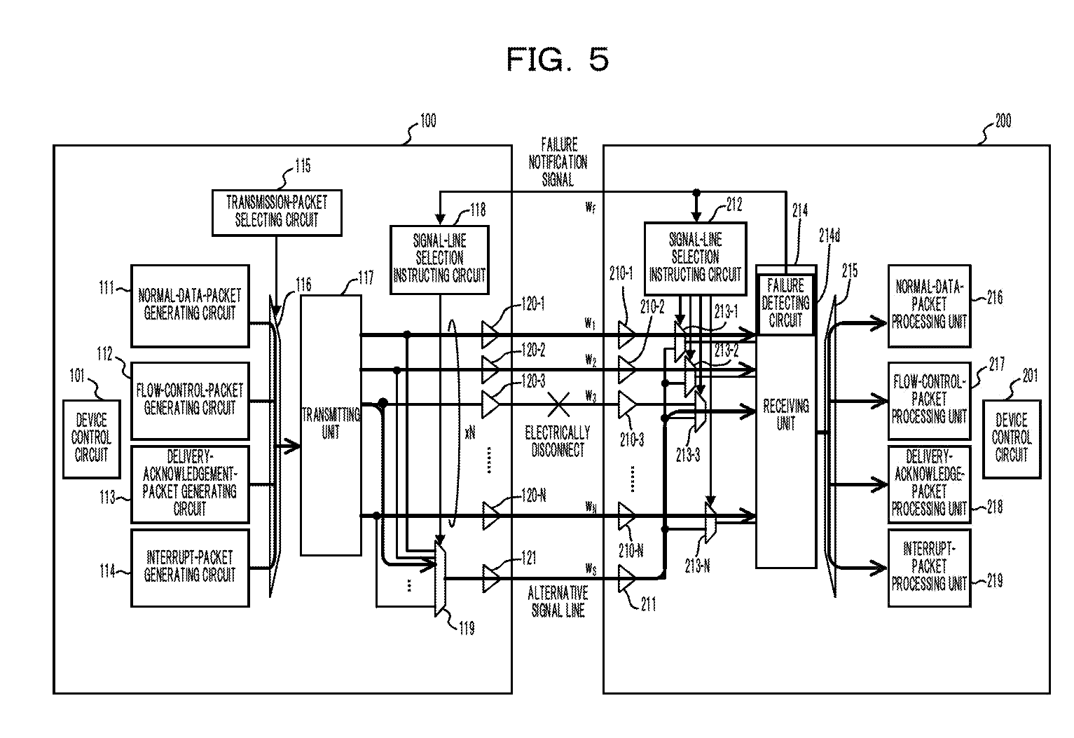

FIG. 3 illustrates flows of packets in a normal state, i.e., when all of the signal lines W1 to WN are working properly in the configuration in FIG. 2. FIG. 4 illustrates flows of signals in the configuration in FIG. 2 when one of the signal lines W1 to WN fails, the failure is detected, and the connection of the failed signal line is switched to the alternative signal line WS. FIG. 5 illustrates flows of packets in the configuration in FIG. 2 after the connection of the failed signal line is switched to the alternative signal line WS.

As illustrated in FIG. 2, N signal lines W1 to WN for transferring packets, the alternative signal line WS to be switched into use when any of the N signal lines W1 to WN fails, and a signal line WF for transmitting a failure notification signal for reporting a switching timing of the failed signal line are connected between the data transmitting device 100 and the data receiving device 200. The data transmitting device 100 includes N transmission buffers 120-1 to 120-N and the data receiving device 200 includes N receiving buffers 210-1 to 210-N. The N signal lines W1 to WN provide connections between the N transmission buffers 120-1 to 120-N and the N receiving buffers 210-1 to 210-N, respectively. The alternative signal line WS provides a connection between a transmission buffer 121 in the data transmitting device 100 and a receiving buffer 211 in the data receiving device 200. The signal line WF for transmitting the failure notification signal provides connection between a signal-line selection instructing circuit 118 provided in the data transmitting device 100 and a signal-line selection instructing circuit 212 provided in the data receiving device 200.

The section included in the data transmitting device 100 and related to transmission of packets to the data receiving device 200 includes a normal-data-packet generating circuit 111 for generating data packets. In addition, the section included in the data transmitting device 100 and related to transmission of packets to the data receiving device 200 further includes a flow-control-packet generating circuit 112 for generating a flow control packet for reporting the state of available spaces of the receiving buffers in the data receiving device 200. The section included in the data transmitting device 100 and related to transmission of packets to the data receiving device 200 further includes a delivery-acknowledgement-packet generating circuit 113 for generating a delivery acknowledgement packet for reporting whether or not the packets are properly received and an interrupt-packet generating circuit 114 for generating an interrupt packet.

The section included in the data transmitting device 100 and related to transmission of packets to the data receiving device 200 further includes a transmission-packet selecting circuit 115 for selecting a packet to be transmitted to the data receiving device 200. The section included in the data transmitting device 100 and related to transmission of packets to the data receiving device 200 further includes a multiplexer 116 and a transmitting unit 117. Under the control of the transmission-packet selecting circuit 115, the multiplexer 116 selects a packet to be transmitted and inputs the selected packet to the transmitting unit 117. The transmitting unit 117 divides the selected packet into N packets and sends the N packets to the N signal lines W1 to WN, respectively. The section included in the data transmitting device 100 and related to transmission of packets to the data receiving device 200 further includes a signal-line selection instructing circuit 118 and a multiplexer 119. When a failure in any of the signal lines W1 to WN is detected, the signal-line selection instructing circuit 118 electrically disconnects the detected failed signal line and switches the connection to the alternative signal line WS. Under the control of the signal-line selection instructing circuit 118, the multiplexer 119 selects from signals output from the transmitting unit 117, a signal to be sent to the alternative signal line WS and sends the selected signal to the alternative signal line WS.

On the other hand, the section included in the data receiving device 200 and related to reception of packets from the data transmitting device 100 includes a normal-data-packet processing unit 216 for processing received data packets and a flow-control-packet processing unit 217 for processing the aforementioned flow control packet. The section included in the data receiving device 200 and related to reception of packets from the data transmitting device 100 further includes a delivery-acknowledgement-packet processing unit 218 for processing the aforementioned delivery acknowledgement packet and an interrupt-packet processing unit 219 for processing the aforementioned interrupt packet. The section included in the data receiving device 200 and related to reception of packets from the data transmitting device 100 further includes a receiving unit 214 for reassembling the packets divided and transmitted through the N signal lines W1 to WN and a failure detecting circuit 214d for detecting an abnormality in the signal lines. The section included in the data receiving device 200 and related to reception of packets from the data transmitting device 100 further includes a signal-line selection instructing circuit 212. When the failure detecting circuit 214d detects a failure, the signal-line selection instructing circuit 212 electrically disconnects the failed signal line and switches the connection to the alternative signal line WS. The section included in the data receiving device 200 and related to reception of packets from the data transmitting device 100 further includes N multiplexers 213-1 to 213-N provided so as to correspond to the N signal lines W1 to WN, respectively. Each of the N multiplexers 213-1 to 213-N selects one of the signal lines W1 to WN and the alternative signal line WS. Under the control of the signal-line selection instructing circuit 212, the N multiplexers 213-1 to 213-N operate to select signals, which are then input to the receiving unit 214. The section included in the data receiving device 200 and related to reception of packets from the data transmitting device 100 further includes a demultiplexer 215 for routing a packet, output from the receiving unit 214, to a corresponding one of the processing units 216 to 219.

The data transmitting device 100 includes a device control circuit 101 for controlling operations of the individual units included in the data transmitting device 100. The data receiving device 200 also includes a device control circuit 201 for controlling operations of the individual units included in the data receiving device 200.

A description will be given below of a flow of an operation of transferring packets between the data transmitting device 100 and the data receiving device 200 in the above described reference example.

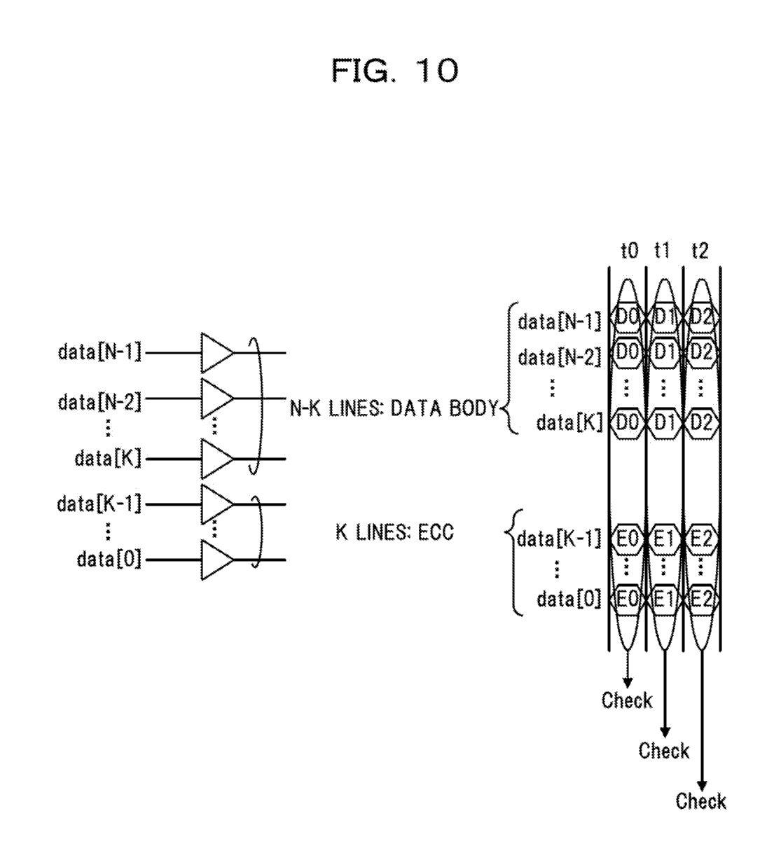

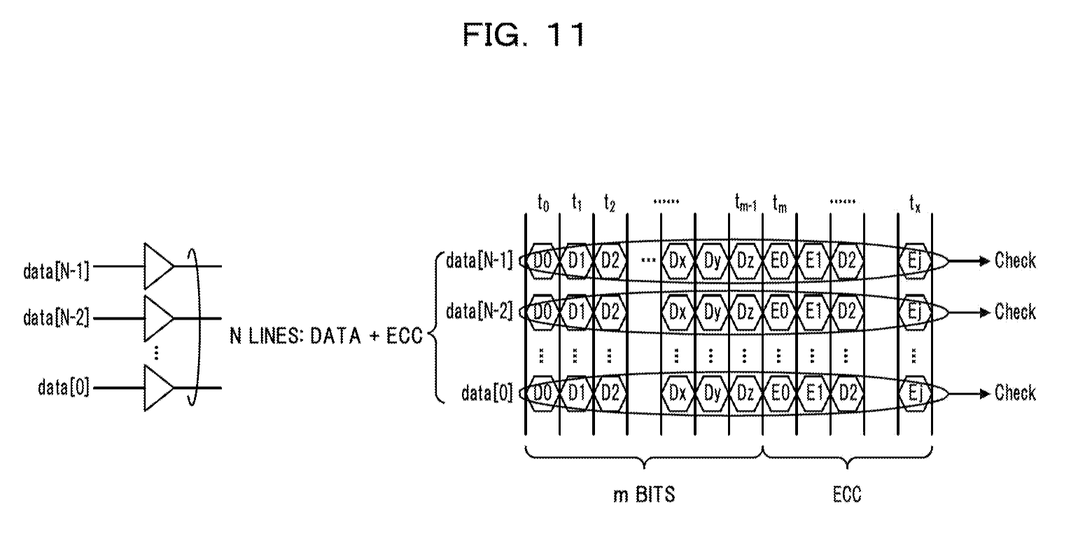

First, an operation in a normal state, i.e., an operation when all of the N signal lines W1 to WN are working properly, the operation will be described with reference to FIG. 3. In this case, in response to a packet transmission request from the packet generating circuits 111 to 114 and under the control of the transmission-packet selecting circuit 115, the multiplexer 116 in the data transmitting device 100 selects a packet to be transmitted and inputs the selected packet to the transmitting unit 117. The transmitting unit 117 divides the input packet into N packets and sends out the divided input packets to the N signal lines W1 to WN. The receiving unit 214 in the data receiving device 200 reassembles the N divided packets transmitted through the N signal lines W1 to WN and determines whether or not the resulting packet has been properly received. Upon determining that the packet has been properly received, the receiving unit 214 routes the packet to a corresponding one of the packet processing units 216 to 219 in accordance with the type of packet. On the other hand, when the receiving unit 214 determines that an abnormality is detected in the received packet, the failure detecting circuit 214d determines that some type of failure occurred in the N signal lines W1 to WN. The contents of the packet determined to be properly received are analyzed by the corresponding one of the packet processing units 216 to 219 and the packet is subjected to necessary processing. In order for the failure detecting circuit 214d to identify a signal line having an abnormality, the packet generating circuits 111 to 114 in the data transmitting device 100 add error check codes (which may be referred to “ECC (Error Check and Correction)” hereinbelow) for identifying a failed signal line to packets generated. A specific method for identifying a signal line having an abnormality is described below with reference to FIGS. 10 and 11. When all of the N signal lines W1 to WN are working properly, the alternative signal line WS is not used to transfer any data.

When the failure detecting circuit 214d in the data receiving device 200 detects a failure in one of the signal lines W1 to WN, operations are performed in the following manner. As illustrated in FIG. 4, the failure detecting circuit 214d in the data receiving device 200 sends failed-signal-line information and a failure notification signal to both the signal-line selection instructing circuit 212 in the data receiving device 200 and the signal-line selection instructing circuits 118 in the data transmitting device 100. The signal-line selection instructing circuit 212 in the data receiving device 200 receives the failure notification signal and switches the connection of the failed signal line to the alternative signal line WS and the signal-line selection instructing circuit 118 in the data transmitting device 100 similarly switches the connection of the failed signal line to the alternative signal line WS. For convenience of description, it is assumed in this case that the failed signal line is only the signal line W3. In this case, the signal-line selection instructing circuit 212 in the data receiving device 200 causes the corresponding multiplexer 213-3 to select the alternative signal line WS. On the other hand, the signal-line selection instructing circuit 118 in the data transmitting device 100 receives the failed-signal-line information and the failure notification signal and instructs the multiplexer 119 so as to connect the alternative signal line WS to an output terminal provided in the transmitting unit 117 and connected to the failed signal line W3. As a result, a signal originally sent from the data transmitting device 100 to the signal line W3 is sent to the alternative signal line WS. Similarly, in the data receiving device 200, the multiplexer 213-3 that has originally selected the signal line W3 selects the alternative signal line WS. Consequently, a signal originally transmitted through the signal line W3 is transmitted through the alternative signal line WS.

As described above, due to the functions of the signal-line selection instructing circuit 118 in the data transmitting device 100 and the signal-line selection instructing circuit 212 in the data receiving device 200, a signal originally transmitted through the signal line W3 is transmitted through the alternative signal line WS. Thereafter, as illustrated in FIG. 5, packet transfer is resumed so that all packets including data packets, a flow control packet, a delivery acknowledgement packet and an interrupt packet are sent out from the transmitting unit 117 as in the case illustrated in FIG. 3. In the data receiving device 200 the receiving unit 214 receives all packets in a manner similar to the transmitting unit 117. As a result of the above described operation, the failed signal line W3 is electrically disconnected and the signal transfer handled by the failed signal line W3 is carried out through the alternative signal line WS. In this case, the data receiving device 200 resumes the reception processing upon detecting that the data transmitting device 100 has electrically disconnected the failed signal line W3, performs switching so that the signal transfer handled by the failed signal line W3 is to be carried out by the alternative signal line WS, and resumes the packet transfer. There are at least three methods for the data receiving device 200 to detect the signal-line connection switching in the data transmitting device 100. In a first method, a special packet is used as an initial packet for resuming transmission, and resumption of packet transmission is detected upon detection of the special packet. In a second method, timers for clocking the same time are provided in both the transmitting side and the receiving side, and after an instruction for switching the signal line connection is received, packet transfer is resumed at a predetermined timing. In a third method, an external control device is prepared to report timing for resuming packet transfer.

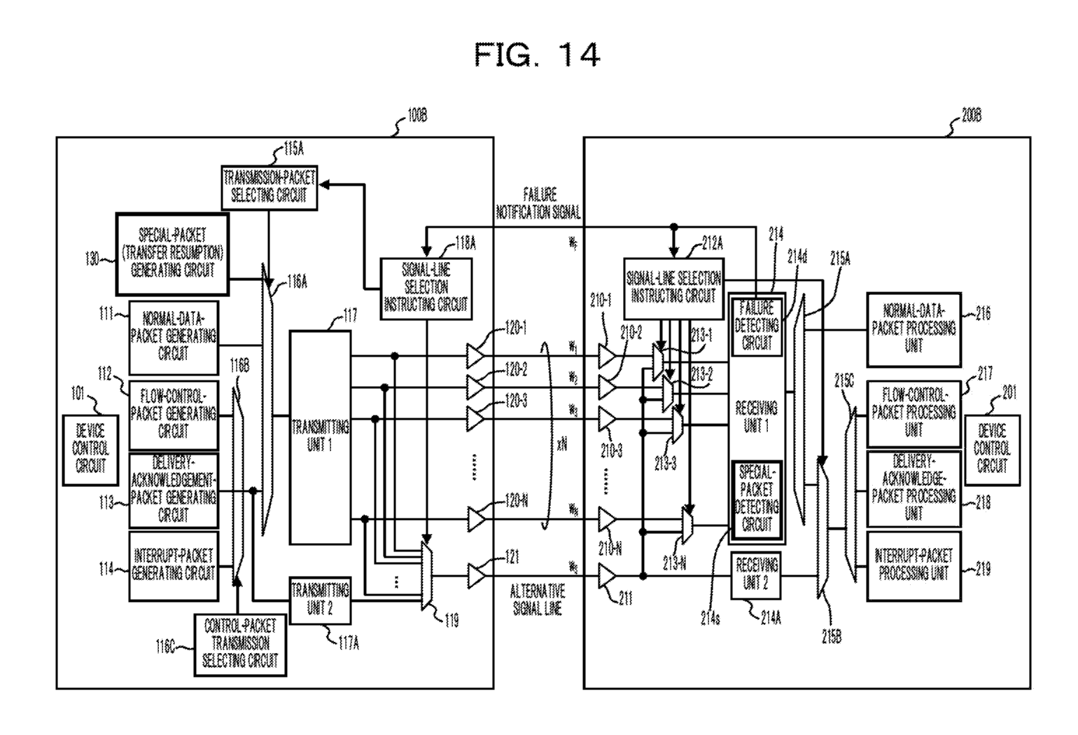

The first to third methods are described below with reference to FIGS. 14 to 19.

In the method for transferring packets between the data transmitting device 100 and the data receiving device 200 in the reference example described above with reference to FIGS. 2 to 5, the alternative signal line WS has the following functions. When one of the signal lines W1 to WN through which packets are transferred fails in a normal operation, the alternative signal line WS is used instead of the failed signal line to continue signal transmission. That is, when all of the signal lines W1 to WN are working properly in a normal operation, the alternative signal line WS is not used. In the reference example, the data transmitting device 100 transfers packets to the data receiving device 200 while checking the amounts of free spaces of the receiving buffers in the data receiving device 200. Thus, when the amounts of free spaces of the receiving buffers are not sufficient, the flow control packet needs to be frequently transferred to report the amounts of free spaces of the receiving buffers. It is presumed that the ratio of the flow control packets to the data packets increases and thus the efficiency of transfer of data packets declines. For an LSI that functions as both a data transmitting device and a data receiving device (e.g., a network adaptor) so as to transfer data upon receiving the data from another device, it is necessary to perform interruption control to issue a notification indicating that the data is received. Since control packets for performing the interruption control are transferred in parallel with transfer of data packets, it is presumed that the efficiency of the transfer of the data packets declines.

According to the method for transferring packets between the data transmitting device and the data receiving device in the embodiment, in the configuration in which multiple signal lines are connected between the data transmitting device and the data receiving device and are used to transfer packets, an alternative signal line is utilized efficiently when all of the multiple signal lines are working properly. This arrangement can enhance the data-packet transfer efficiency and can improve the performance of the information processing apparatus.

In the embodiment, control packets for flow control, delivery acknowledgement, interruption, and so on are sent out to the alternative signal line in a normal operation. The data transmitting device includes a control-packet transmission selecting circuit for selecting which one of the multiple types of control packets is to be sent out to the alternative signal line and an alternative-signal-line transmitting unit for sending out the control packet to the alternative signal line. The data receiving device includes an alternative-signal-line receiving unit for receiving the control packet that arrives at the data receiving device through the alternative signal line.

According to the embodiment, control packets for flow control, delivery acknowledgement, interruption, and so on which are related to transfer of data packets are transmitted through the alternative signal line which is not used in the normal operation in the reference example described above. With this arrangement, the rate of transferring of data packets increases and the packet transfer efficiency improves.

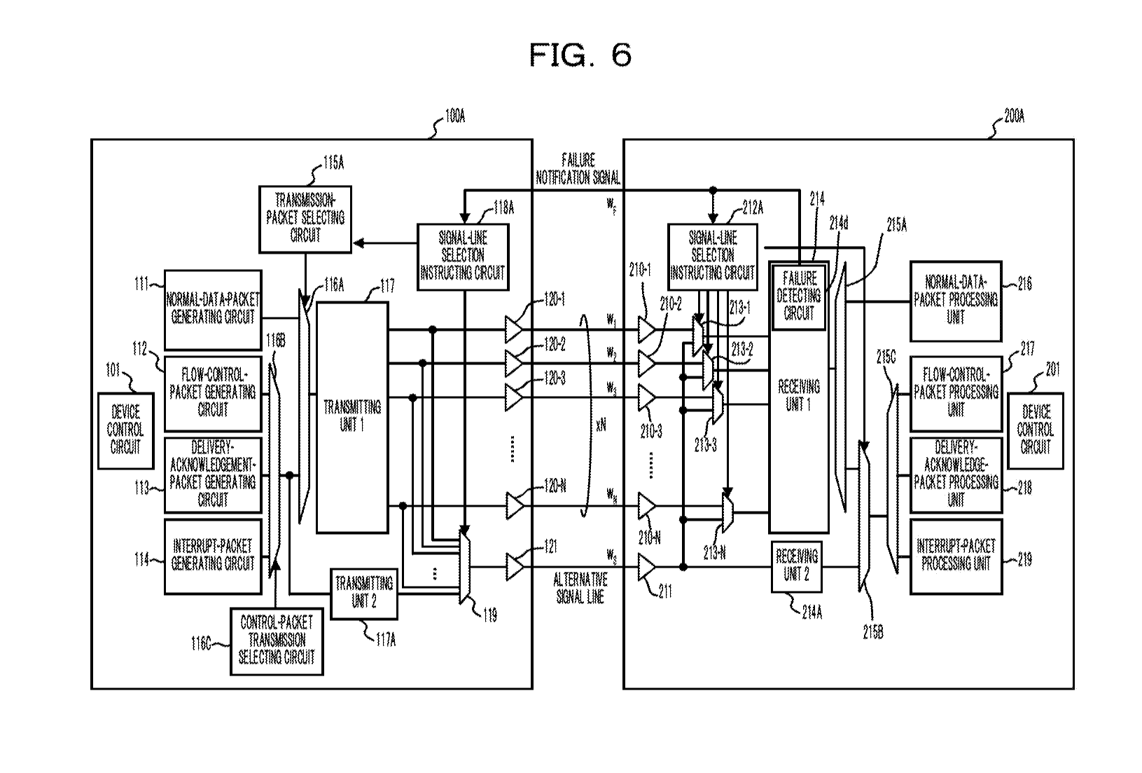

FIG. 6 illustrates sections, included in a data transmitting device 100A and a data receiving device 200A, according to the embodiment and related to transfer of packets between the data transmitting device 100A and the data receiving device 200A. Sections that are included in the data transmitting device 100A and the data receiving device 200A and that are not related to transfer of packets therebetween may have configurations of known LSIs, such as those of a CPU and MCU, and detailed descriptions thereof are not given hereinafter.

In the sections included in the data transmitting device 100A and the data receiving device 200A in the embodiment and related to transfer of packets therebetween, units that are same as those in the sections included in the data transmitting device 100 and the data receiving device 200 in the above described reference example and related to transfer of packets therebetween are denoted by the same reference numerals, and descriptions thereof are not given below.

The section included in the data transmitting device 100A in the embodiment and related to transmission of packets to the data receiving device 200A includes a control-packet transmission selecting circuit 116C for selecting a control packet to be transmitted and a transmitting unit 117A for transmitting the selected control packet. The section included in the data transmitting device 100A in the embodiment and related to transmission of packets to the data receiving device 200A includes an instruction signal line between a signal-line selection instructing circuit 118A and a transmission-packet selecting circuit 115A. Thus, when a failure in any of the N signal lines W1 to WN is detected, the signal-line selection instructing circuit 118A issues an instruction for switching the connection of the failed signal line to the alternative signal line WS. In this case, the signal-line selection instructing circuit 118A issues the instruction to the transmission-packet selecting circuit 115A through the aforementioned instruction signal line, so as to switch the connections of the signal lines so that control packets are output to the transmitting unit 117. The section included in the data transmitting device 100A in the embodiment and related to transmission of packets to the data receiving device 200A further includes a multiplexer 116B for selecting which of the three types of control packet is to be transmitted. The operation of the multiplexer 116B is controlled by the control-packet transmission selecting circuit 116C. The section included in the data transmitting device 100A in the embodiment and related to transmission of packets to the data receiving device 200A further includes a multiplexer 116A for selecting one of a data packet generated by the normal-data-packet generating circuit 111 and the control packet selected by the multiplexer 116B. The operation of the multiplexer 116A is controlled by the transmission-packet selecting circuit 115A.

The section included in the data receiving device 200A and related to reception of packets from the data transmitting device 100A includes a receiving unit 214A, a signal-line selection instructing circuit 212A, a multiplexer 215B, and a switching signal line. The receiving unit 214A receives the control packet. The signal-line selection instructing circuit 212A controls the multiplexer 215B via the switching signal line. During a failure of one or more of the N signal lines W1 to WN, the signal-line selection instructing circuit 212A issues an instruction for switching the connection of the failed signal line. The signal-line selection instructing circuit 212A also controls the multiplexer 215B in order to route a control packet, output from the receiving unit 214, to a corresponding one of the packet processing units 217 to 219. The section included in the data receiving device 200A and related to reception of packets from the data transmitting device 100A further includes demultiplexers 215A and 215C. The demultiplexer 215A routes a packet, output from the receiving unit 214, to a corresponding one of the normal-data-packet processing unit 216 and the multiplexer 215B. The demultiplexer 215C routes the control packet, selected by the multiplexer 215B, to a corresponding one of the packet processing units 217 to 219.

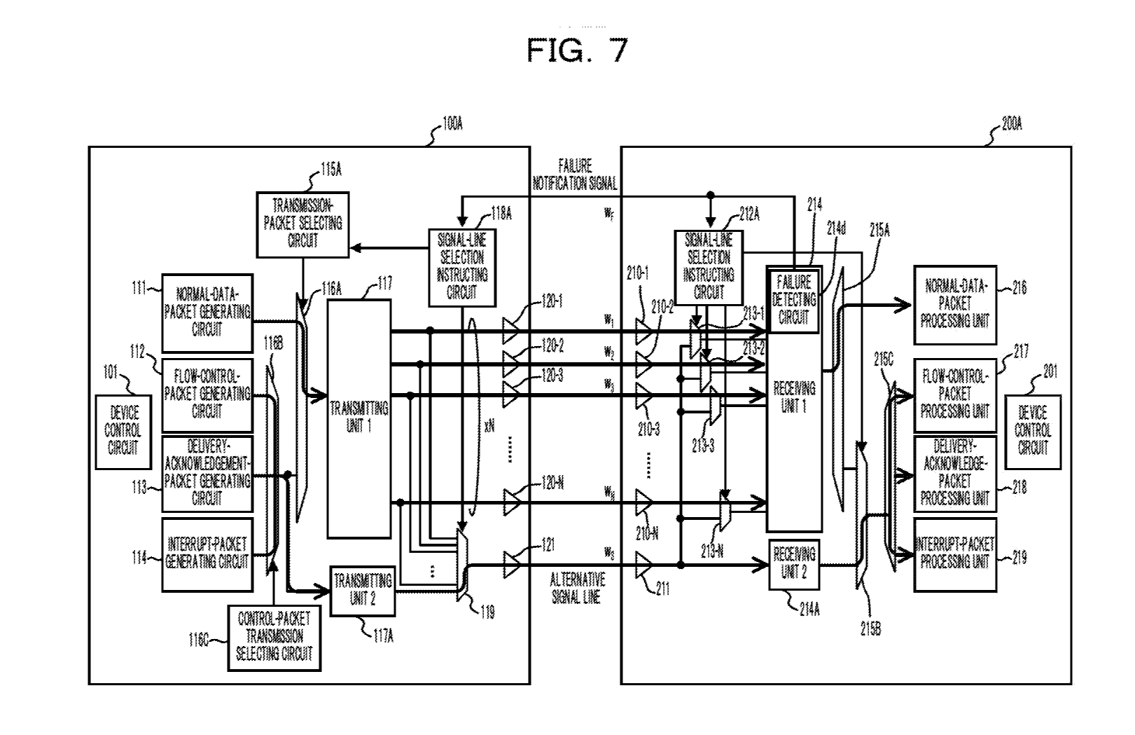

A flow of an operation that is performed by the data transmitting device 100A and the data receiving device 200A in the embodiment described above in conjunction with FIG. 6 and that is related to transfer of packets therebetween will now be described with reference to FIGS. 7 to 9.

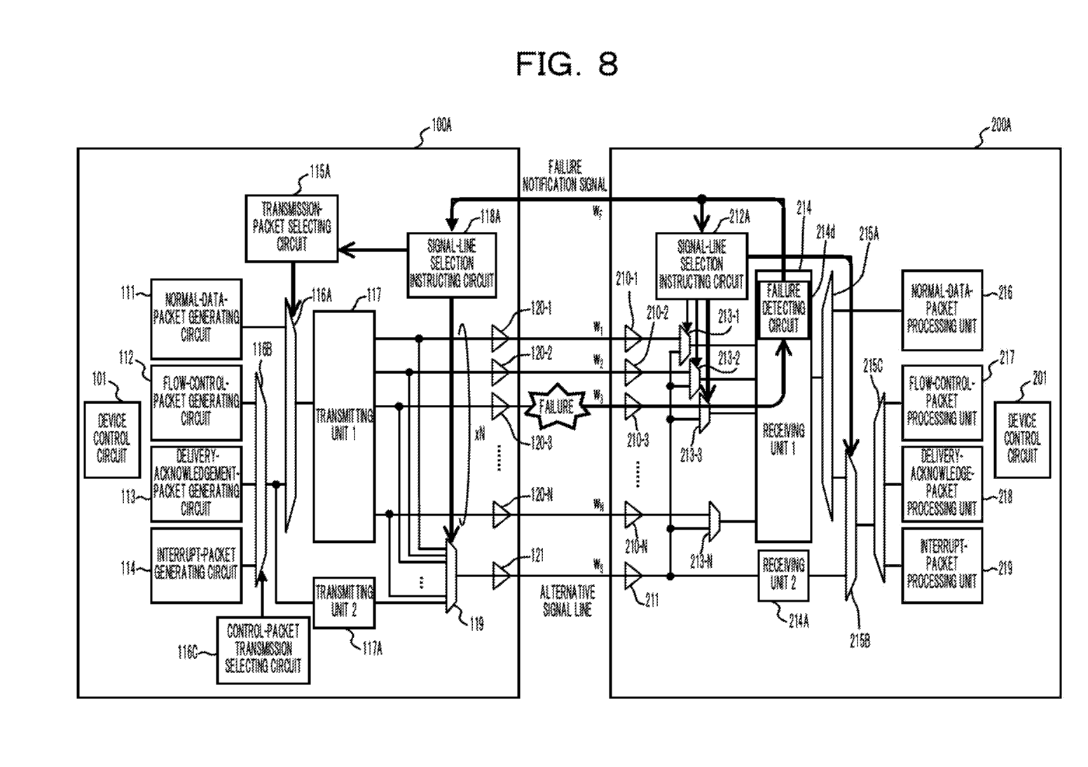

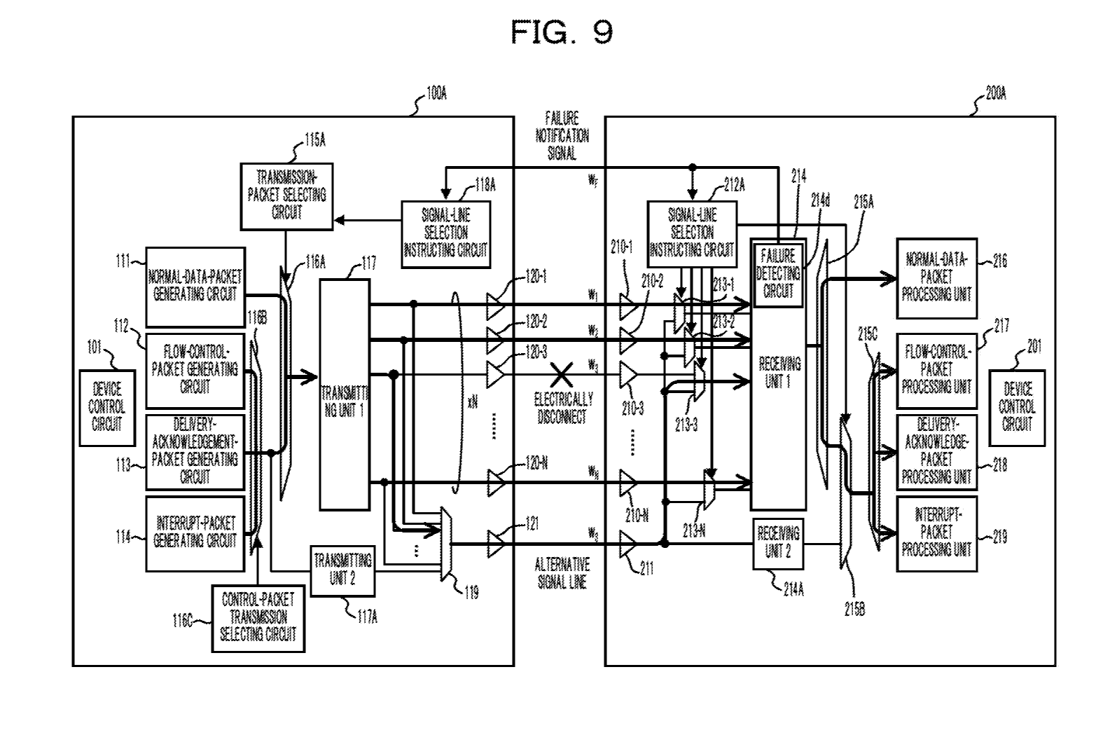

FIG. 7 illustrates flows of packets in a normal operation (i.e., when all of the N signal lines W1 to WN are working properly). FIG. 8 illustrates flows of signals when a failure is detected in one signal line and the connection of the failed signal line is switched to the alternative signal line. FIG. 9 illustrates flows of packets after the connection of the failed signal line is switched to the alternative signal line.

As illustrated in FIG. 7, in the normal operation, upon receiving a data-packet transmission request from the normal-data-packet generating circuit 111 in the data transmitting device 100A, the transmitting unit 117 divides a data packet into N data packets and sends out the N data packets to N signal lines W1 to WN. In this case, the transmission-packet selecting circuit 115A in the data transmitting device 100A controls the multiplexer 116A to selectively connect the normal-data-packet generating circuit 111 to the transmitting unit 117. The receiving unit 214 in the data receiving device 200A reassembles the N divided data packets transmitted through the N signal lines W1 to WN. Upon determining that the data packet is properly received, the receiving unit 214 sends the data packet to the normal-data-packet processing unit 216. Thus, under the control of the signal-line selection instructing circuit 212A, each of the multiplexers 213-1 to 213-N in the data receiving device 200A selectively connects a corresponding one of the N signal lines W1 to WN to the receiving unit 214. The demultiplexer 215A passes the packet, output from the receiving unit 214, to the normal-data-packet processing unit 216.

On the other hand, control packets generated by the packet generating circuits 112, 113, and 114 are sent to the transmitting unit 117A via the multiplexer 116B and are further sent out to the alternative signal line WS via the multiplexer 119 and the transmission buffer 121. The control packets transmitted through the alternative signal line WS are received by the receiving unit 214A in the data receiving device 200A via the receiving buffer 211. The control packets are routed from the receiving unit 214A to the corresponding packet processing units 217, 218, and 219 via the multiplexer 215B and the demultiplexer 215C. Under the control of the control-packet transmission selecting circuit 116C in the data transmitting device 100A, the multiplexer 116B selects any of the control packets generated by the control-packet generating circuits 112, 113, and 114 and passes the selected control packet to the transmitting unit 117A. Under the control of the signal-line selection instructing circuit 118A, the multiplexer 119 selectively sends out the packet outputted from the transmitting unit 117A to the alternative signal line WS. Under the control of the signal-line selection instructing circuit 212A in the data receiving device 200A, the multiplexer 215B selectively outputs the packet outputted from the receiving unit 214A to the demultiplexer 215C.

In this case, when any of the N signal lines W1 to WN fails, the failure detecting circuit 214d in the data receiving device 200A detects the failure in the signal line, as illustrated in FIG. 8. For convenience of description, it is assumed that the signal line W3 fails. The failure detecting circuit 214d sends failure-information of the failed signal line W3 and a failure notification signal to the signal-line selection instructing circuit 212A in the data receiving device 200A and the signal-line selection instructing circuit 118A in the data transmitting device 100A.

The data receiving device 200A receives the failure-information of the failed signal line W3 and the failure notification signal. Then, under the control of the device control circuit 201, the data receiving device 200A stops the packet reception and processing and switches the connection of the failed signal line W3 to the alternative signal line WS. That is, under the control of the signal-line selection instructing circuit 212A in the data receiving device 200A, the connection of the multiplexer 213-3 corresponding to the failed signal line W3 is switched so that the alternative signal line WS is selectively connected to the receiving unit 214. Under the control of the signal-line selection instructing circuit 212A, the connection of the multiplexer 215B is switched so that the control packet output from the demultiplexer 215A is selectively connected to the demultiplexer 215C.

The data transmitting device 100A also receives the failure-information of the failed signal line W3 and the failure notification signal. Then, under the control of the device control circuit 101, the data transmitting device 100A stops new-packet generation and transmission and switches the connection of the failed signal line W3 to the alternative signal line WS. At this point, the output destination of the control packets to be output from the control-packet generating circuits 112, 113, and 114 is switched from the transmitting unit 117A to the transmitting unit 117. Thus, the connection of the multiplexer 116A is switched so that outputs of the multiplexer 116B as well as outputs of the normal-data-packet generating circuit 111 are selectively sent to the transmitting unit 117. The connection of the multiplexer 116A is switched by the transmission-packet selecting circuit 115A when it receives an instruction from the signal-line selection instructing circuit 118A. Under the control of the signal-line selection instructing circuit 118A, the connection of the multiplexer 119 is also switched so that the connection destination of the alternative signal line WS is switched from the transmitting unit 117A to the output terminal that is provided in the transmitting unit 117 and that corresponds to the failed signal line W3.

When the above described signal line switching in the data receiving device 200A and the data transmitting device 100A is completed, packet transfer is resumed as illustrated in FIG. 9, under the controls of the device control circuit 201 and the device control circuit 101. In this case, the data transmitting device 100A sends control packets, e.g., a flow control packet, a delivery acknowledgement packet, and an interrupt packet, in addition to the data packets generated by the normal-data-packet generating circuit 111, to the transmitting unit 117. The control packets are sent to the transmitting unit 117 via the multiplexer 116B and the multiplexer 116A. The transmitting unit 117 then divides the packet into N packets, as in the state before the signal lines are switched (which state has been described above with reference to FIG. 7), and the transmitting unit 117 sends out the N packets to a total of N signal lines including the alternative signal line WS in addition to N−1 signal lines W1, W2, and W4 to WN that have no failure. In this case, the signal sent to the failed signal line W3 in the state illustrated in FIG. 7 before the switching of the signal lines is sent to the alternative signal line WS via the multiplexer 119. On the other hand, the control packets sent out to the alternative signal line WS via the transmitting unit 117A and the multiplexer 119 in the state before the switching of the signal lines are output to the transmitting unit 117 via the multiplexer 116A. Thereafter, the control packet is divided into N packets by the transmitting unit 117 and the N divided packets are sent to N signal lines including the alternative signal line WS in addition to the N−1 signal lines W1, W2, and W4 to WN.

The receiving unit 214 in the data receiving device 200A receives the packets transmitted through the total of N signal lines including the alternative signal line WS in addition to the N−1 signal lines W1, W2, and W4 to WN. The receiving unit 214 then reassembles the divided packets transmitted through the N signal lines W1, W2, W4 to WN, and WS and checks whether or not the packet is properly received. The packet determined to be properly received is routed to a corresponding one of the packet processing units 216 to 219 in accordance with the type of packet. In this case, the failed signal line W3 is electrically disconnected and is not used for the packet transfer. Thus, the multiplexer 213-3 corresponding to the failed signal line W3 selectively outputs the signals transmitted through the alternative signal line WS, to the receiving unit 214. The multiplexer 21513 selectively outputs the control packet routed by the demultiplexer 215A, to the demultiplexer 215C.

A description is given below of a method in which the failure detecting circuit 214d in the data receiving device 200A detects a failure in the N signal lines W1 to WN. A known method may be used as a method for the failure detecting circuit 214d to detect a failure in the N signal lines W1 to WN. A specific example of an available method will now be described. As one available method, as illustrated in FIG. 10, N signal lines are divided into N-K signal lines and K signal lines and the data transmitting device sends a data body to the N-K signal lines and sends, to the remaining K signal lines, an ECC indicating which of the N signal lines has an abnormality. The data receiving device checks data received at the regular intervals t0, t1, t2, . . . to identify a failed signal line.

As another available method, as illustrated in FIG. 11, the data transmitting device adds an additional error checking code, such as parity, ECC and CRC, to m-bit data to be sent out to the N signal lines. The data receiving device checks the m-bit data and its subsequent error checking code and determines that a signal line from which an error was detected as a result of the checking has a failure.

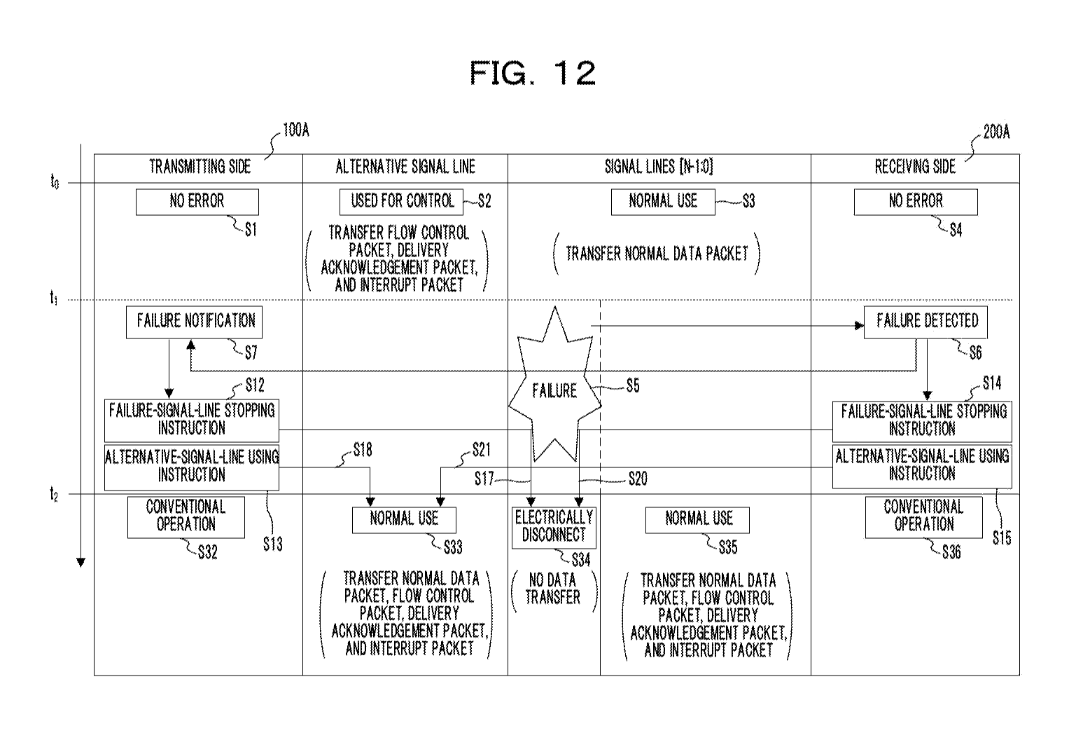

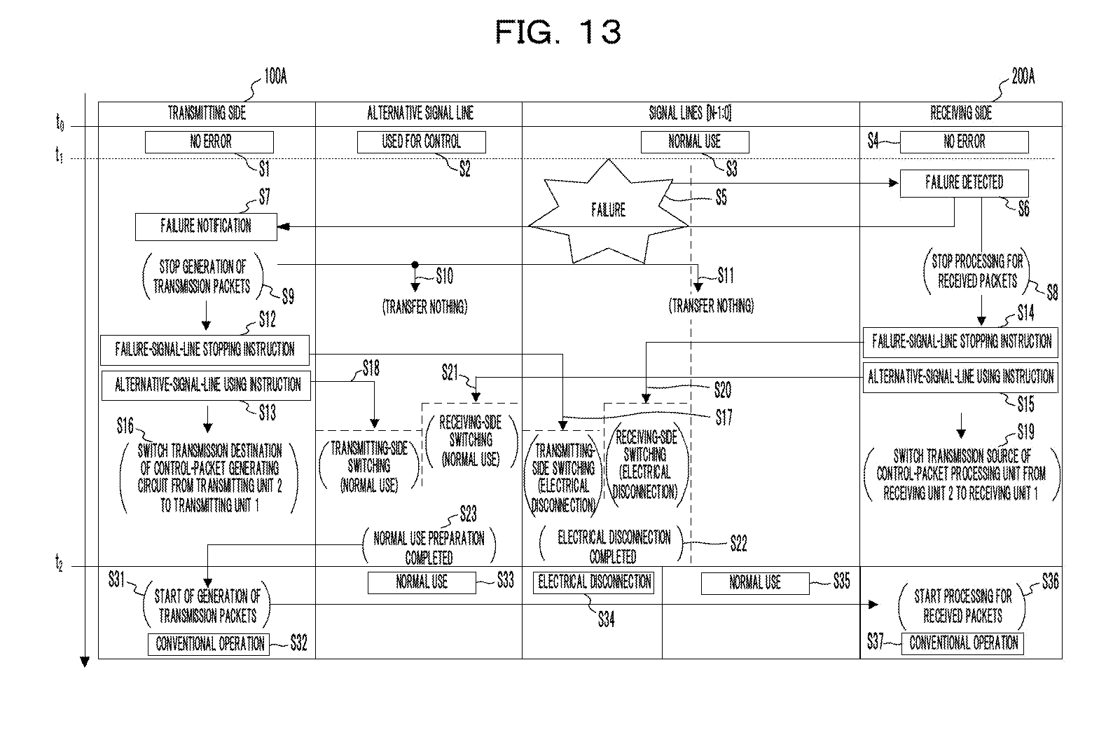

The flow of the signal-line switching operation described above with reference to FIGS. 7 to 9 will be described again with reference to FIGS. 12 and 13. At time t0 in FIGS. 12 and 13, no error exists in the data transmitting device 100A and the data receiving device 200A (S1 and S4), N signal lines W1 to WN are used to transmit data packets (S3), and the alternative signal line WS is used to transmit a control packet (S2).

In this case, it is assumed that one (the signal lines W3 as in above described case) of the N signal lines W1 to WN (S5) fails at time t1. The failure is detected by the failure detecting circuit 214d in the data receiving device 200A (S6), and information indicating the failure is transmitted to the data transmitting device 100A (S7). Under the control of the device control circuit 201, the data receiving device 200A stops processing for received packets (S8). Under the control of the device control circuit 101, the data transmitting device 100A stops generation of transmission packets (S9). As a result, the N signal lines W1 to WN and the alternative signal line WS are not used for signal transmission (S11 and S10).

The signal-line selection instructing circuit 118A in the data transmitting device 100A issues an instruction for stopping the use of the failed signal line W3 (S12) and an instruction for using the alternative signal line WS (S13) and the signal-line selection instructing circuit 212A in the data receiving device 200A issues an instruction for stopping the use of the failed signal line W3 (S14) and an instruction for using the alternative signal line WS (S15). As a result, the connections of the multiplexers 116A and 119 in the data transmitting device 100 are switched. Consequently, the transmission destination of the control packet is switched from the transmitting unit 117A to the transmitting unit 117 (S16). The output terminal provided in the transmitting unit 117 and connected to the failed signal line W3 is also connected to the alternative signal line WS. Consequently, the signal transmitted through the failed signal line W3 can be transmitted through the alternative signal line WS (S17 and S18).

The connections of the receiving-side multiplexer 213-3 corresponding to the failed signal line W3 and the multiplexer 215B are also switched. As a result, the source that receives the control packet and that corresponds to the packet processing units 217 to 219 for processing the control packet is switched from the receiving unit 214A to the receiving unit 214 (S19). The input terminal provided in the receiving unit 214 and connected to the failed signal line W3 is connected to the alternative signal line WS. Consequently, the signal originally received through the failed signal line W3 can be received through the alternative signal line WS (S20 and S21). That is, the failed signal line W3 is electrically disconnected (S22) and, the alternative signal line WS can be used instead of the failed signal line W3 (step S23).

At a point when the failed signal line W3 is electrically disconnected (S22) and the alternative signal line WS becomes usable (S23), i.e., at a point of time t2, the following operations are performed under the control of the device control circuit 101. As in the case described above, the packet generating circuits 111 to 114 in the data transmitting device 100A start generating transmission packets at time t0 (S31 and S32). In this case, N−1 signal lines W1, W2, and W4 to WN having no failure and the alternative signal line WS are used to transmit signals (S33 and S35) and the failed signal line W3 is in an electrically disconnected state (S34). Under the control of the device control circuit 201, the data receiving device 200A receives the packets transmitted through the total of N signal lines including the alternative signal line WS in addition to N−1 signal lines W1, W2, and W4 to WN, and performs the following operation, as in the above described case at time t0. That is, the packet processing units 216 to 219 start processing for received packets (S36 and S37).

A description is given below of a specific method for the data receiving device 200A to detect signal-line switching. The “signal-line switching” in this case refers to connection switching performed so that the alternative signal line WS is used instead of a failed signal line (the signal line W3 in the above described example) when any of the N signal lines W1 to WN fails.

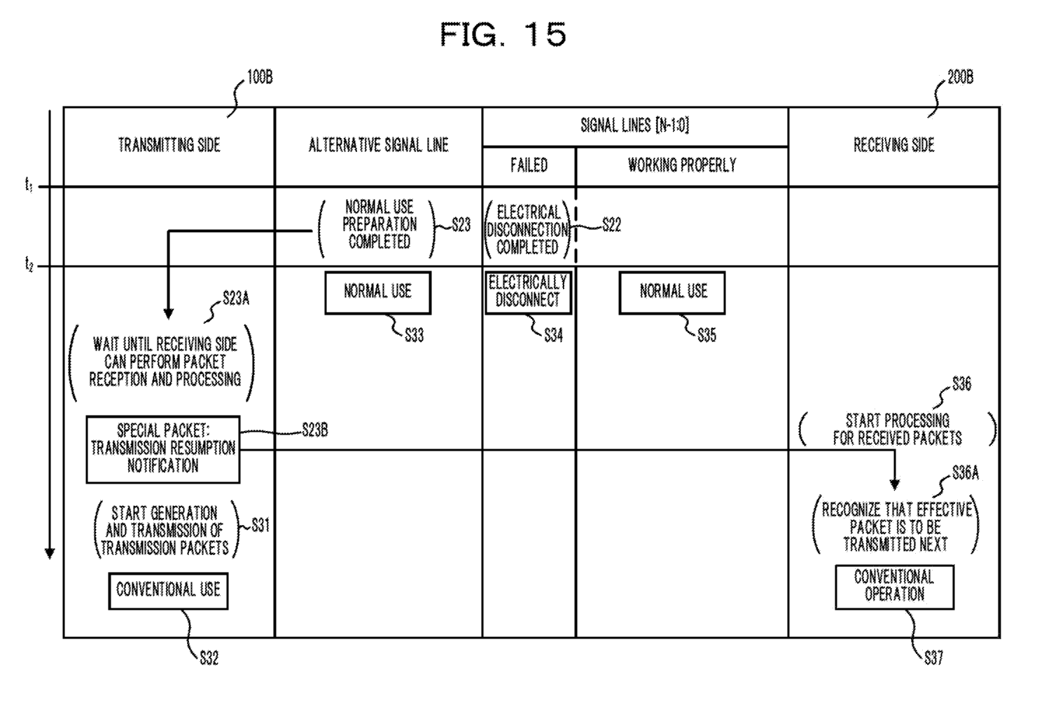

In the first method described above as a specific method for the data receiving device 200 to detect signal-line switching, a special packet is used to issue a notification. The first method will now be described with reference to FIGS. 14 and 15.

The “special packet” as used herein refers to a packet for notifying the receiving unit 214 that an effective packet is to be transferred subsequent to the current packet.

FIG. 14 illustrates sections included in a data transmitting device 100B and a data receiving device 200B and related to packet transfer when the first method is used. In this case, the data transmitting device 100B has a special-packet generating circuit 130 for generating a special packet and the data receiving device 200B has a special-packet detecting circuit 214s for detecting the special packet. Since other sections are analogous to the sections that are included in the data transmitting device 100A and the data receiving device 200A in FIG. 6 and that are related to packet transfer, redundant descriptions are not given hereinafter.

FIG. 15 illustrates a flow of an operation after the operation immediately before completion of the preparation of switching the connection from the failed signal line W3 to the alternative signal line WS at time t2 in FIG. 12. The flow of an operation before the operation immediately before completion of the preparation of switching the connection from the failed signal line W3 to the alternative signal line WS at time t2 is analogous to the operations described above with reference to FIGS. 12 and 13, and redundant descriptions are not given hereinafter.

The data transmitting device 100B switches the connection from the failed signal line W3 to the alternative signal line WS (S23). Under the control of the device control circuit 101, the data transmitting device 100B waits for an amount of time required for the data receiving device 200B to be able to receive and process packets (S23A). Thereafter, the special-packet generating circuit 130 in the data transmitting device 100B generates a special packet which is then transmitted to the data receiving device 200B via the multiplexer 116A and the transmitting unit 117 (S23B), as in the case of the transmission of other packets. At this point, the data receiving device 200B is already in a state in which it can receive and process packets. When the special packet is received by the receiving unit 214 in the data receiving device 200B and is detected by the special-packet detecting circuit 214s, the device control circuit 201 determines that an effective packet is to be transmitted in the next cycle (S36A). Thereafter, under the control of the device control circuits 101 and 201, a total of N signal lines including the alternative signal line WS and the N−1 signal lines other than the failed signal line W3 are used to start transfer of data packets and control packets between the data transmitting device 100B and the data receiving device 200B, as in the case before the failure of the signal line W3.

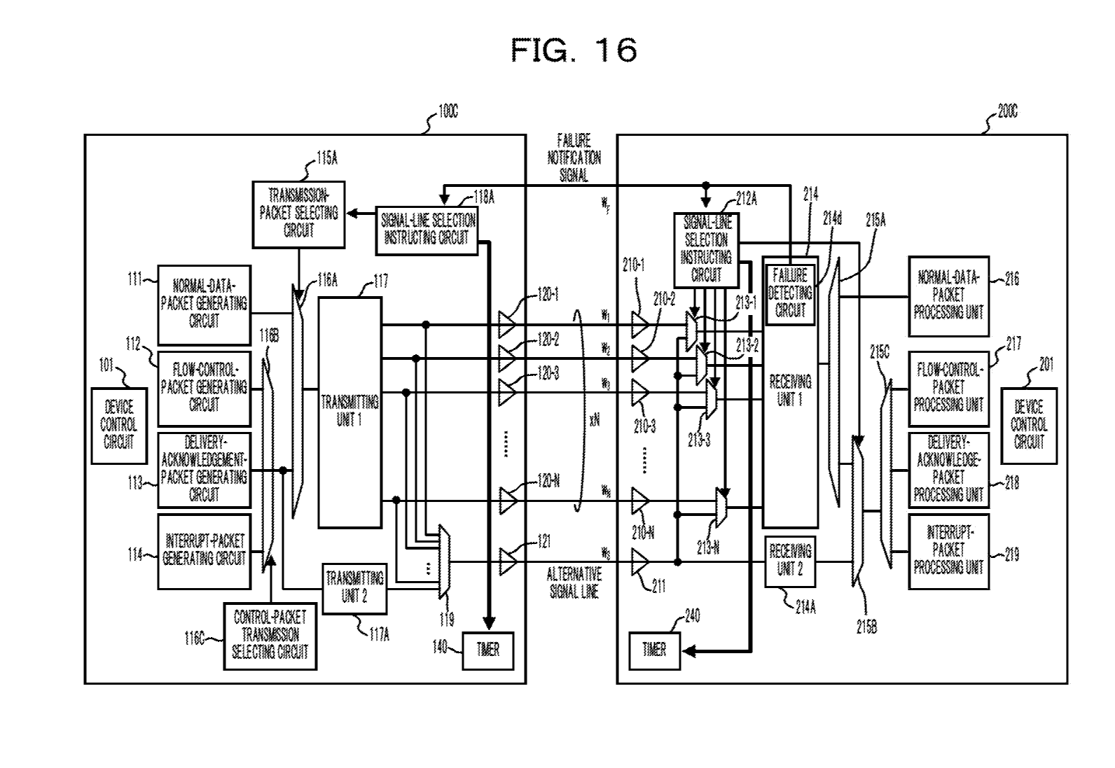

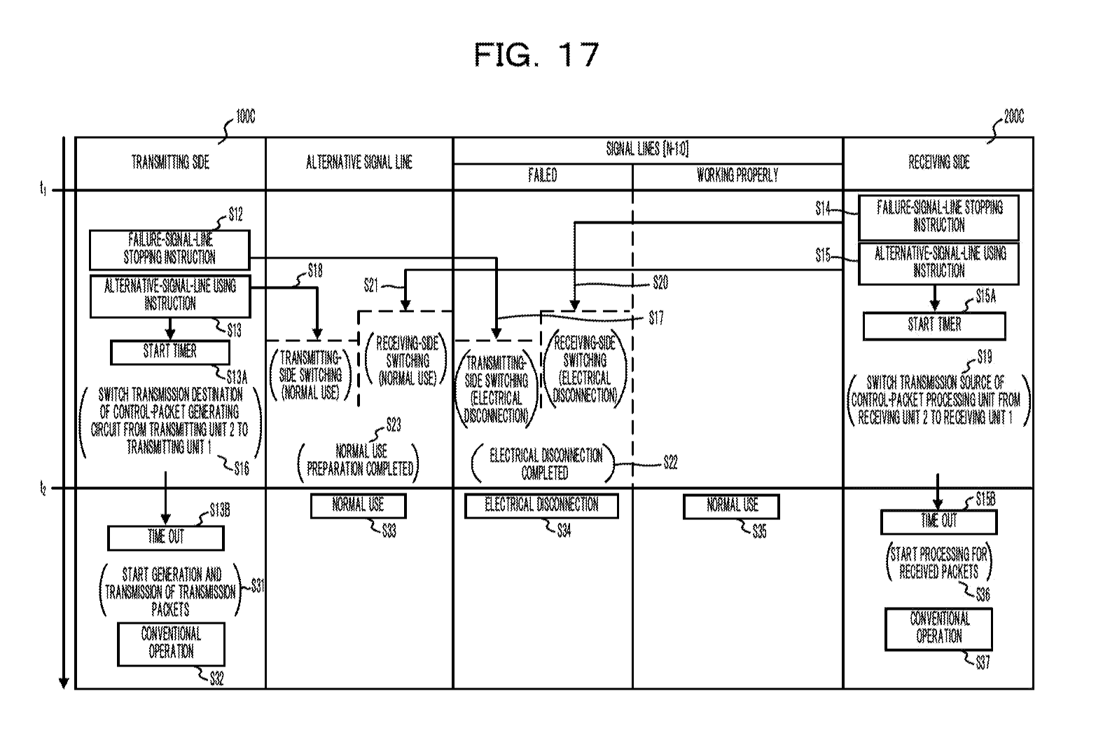

In the second method described above as a specific method for the data receiving device to detect signal-line switching, timer-based management is employed. The second method will now be described with reference to FIGS. 16 and 17.

FIG. 16 illustrates sections included in a data transmitting device 100C and a data receiving device 200C and related to transfer of packets therebetween when the second method described above is used. In this case, the data transmitting device 100C has a timer 140 and the data receiving device 200C also has a timer 240. The timer 140 in the data transmitting device 100C is connected to the signal-line selection instructing circuit 118A and the timer 240 in the data receiving device 200C is connected to the signal-line selection instructing circuit 212A. Since other sections are analogous to those included in the data transmitting device 100A and the data receiving device 200A in FIG. 6 and that are related to transfer of packets therebetween, redundant descriptions are not given hereinafter.

FIG. 17 illustrates a flow of the operation after the instructions for stopping the failed signal line are issued in S12 and S14 described above and illustrated in FIG. 12. Since the operation before the instructions for stopping the failed signal line in S12 and S14 is analogous to that described with reference to FIGS. 12 and 13, redundant descriptions are not given hereinafter.

The instructions for stopping the failed signal line (S12 and S14) and the instructions for using the alternative signal line (S13 and S15) are output from the signal-line selection instructing circuits 118A and 212A, respectively, so as to switch the connections of the failed signal line W3 to the alternative signal line WS. At time same time, the signal-line selection instructing circuits 118A and 212A start the timers 140 and 240, respectively (S13A and S15A). The timers 140 and 240 are set to have a larger time duration than a time duration used for the data transmitting device 100C and the data receiving device 200C to be able to switch the connections of the failed signal line W3 to the alternative signal line WS to resume the packet generation and transmission and the packet reception and processing. The operation of switching from the failed signal line W3 to the alternative signal line WS refers to an operation in which the connections of the multiplexers 116A and 119 are switched in response to the failed-signal-line stopping instruction (S12) and the alternative-signal-line using instruction (S13) and the connections of the multiplexers 231-3 and 215B are switched in response to the failed-signal-line stopping instruction (S14) and the alternative-signal-line using instruction (S15).

When the preset time is clocked (S13B and S15B) after the timers 140 and 240 are started, the following operations are performed under the control of the device control circuit 101 in the data transmitting device 100C and the device control circuit 201 in the data receiving device 200C. In the data transmitting device 100C, the packet generating circuits 111 to 114, the transmitting unit 117, and so on resume the packet generation and transmission (S31 and S32). In the data receiving device 200C, the receiving unit 214, the packet processing units 216 to 219, and so on resume the packet reception and processing (S36 and S37). In this case, in order to ensure that the packet transmitted as a result of the packet transmission resumption at the data transmitting device 100C does not arrive at the receiving unit 214 earlier than the resumption of the reception and processing performed by the data receiving device 200C, setting is performed in the following manner. The time duration of the timer 240 in the data receiving device 200C is set to be shorter than the time duration of the timer 140 in the data transmitting device 100C. Under the control of the device control circuits 101 and 201, a total of N signal lines including the alternative signal line WS and the N−1 signal lines other than the failed signal line W3 are used to start transfer of data packets and control packets between the data transmitting device 100C and the data receiving device 200C, as in the case before the failure of the signal line W3.

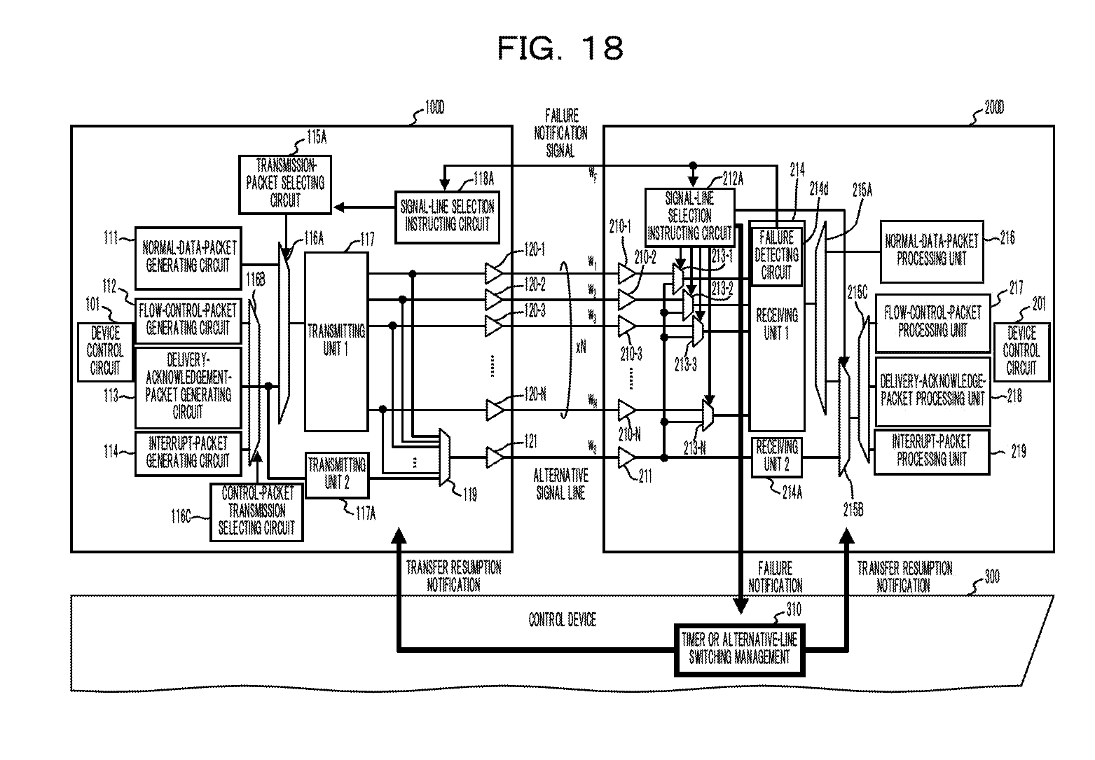

FIG. 18 illustrates sections included in a data transmitting device 100D and a data receiving device 200D and related to transfer of packets therebetween when the third method described above is used. In this case, a control device 300 is provided external to the data transmitting device 100D and the data receiving device 200D. The control device 300 has therein a signal-line switching management circuit 310 to which the data transmitting device 100D and the data receiving device 200D are connected. More specifically, the signal-line selection instructing circuit 118A in the data transmitting device 100D and the signal-line selection instructing circuit 212A in the data receiving device 200D are connected to the signal-line switching management circuit 310. Since other sections are analogous to the sections that are included in the data transmitting device 100A and the data receiving device 200A in FIG. 6 and that are related to transfer of packets therebetween, redundant descriptions are omitted hereinafter.

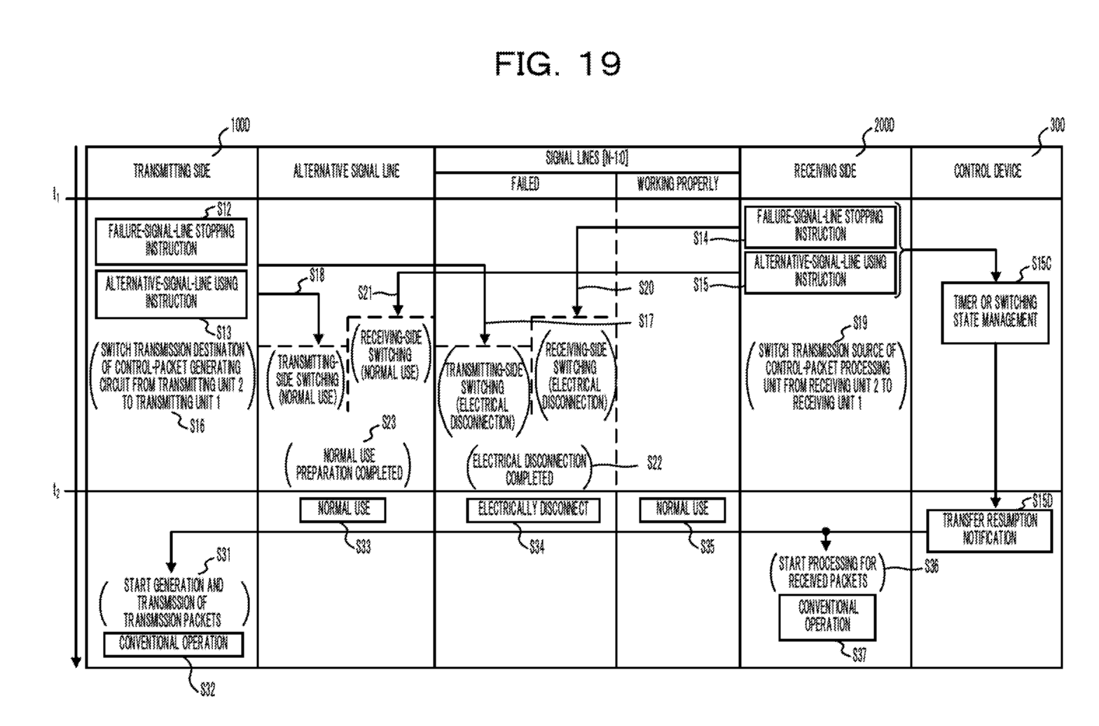

FIG. 19 illustrates a flow of the operation after issuance of the failed-signal-line stopping instructions in S12 and S14 described above and illustrated in FIG. 12. Since the operation before issuance of the failed-signal-line stopping instructions in S12 and S14 is analogous to that described above with reference to FIGS. 12 and 13, redundant descriptions are omitted hereinafter.

The failed-signal-line stopping instructions (S12 and S14) and the alternative-signal-line using instructions (S13 and S15) are output from the signal-line selection instructing circuits 118A and 212A, respectively, so as to switch the connections of the failed signal line W3 to the alternative signal line WS. At the same time, the signal-line selection instructing circuit 118A and 212A issue notifications to the signal-line switching management circuit 310 in the control device 300 indicating that signal-line switching is to be performed due to a signal-line failure. Upon receiving the notifications, the signal-line switching management circuit 310 performs the following operation. After the operation of switching from the failed signal line W3 to the alternative signal line WS, the signal-line switching management circuit 310 determines a timing at which the data transmitting device 100D resumes the packet generation and transmission (S15C) and also determines timing at which the data receiving device 200D resumes the packet reception and processing (S15D). The timing determinations are made through timer-based management or through signal monitoring, for example.

In the case of the timer-based management, the signal-line switching management circuit 310 starts an internal timer (S15C) when the notifications indicating that the signal-line switching is to be performed due to a signal-line failure are received from the signal-line selection instructing circuits 118A and 212A, as in the second method described above. The internal timer is set to have a time duration longer than a time duration used for the data transmitting device 100D and the data receiving device 200D to be able to switch the connections of the failed signal line W3 to the alternative signal line WS to resume the packet generation and transmission and the packet reception and processing. When the preset time is clocked after the internal timer is started, the signal-line switching management circuit 310 issues transfer resumption notifications to the device control circuit 101 in the data transmitting device 100D and the device control circuit 201 in the data receiving device 200D (S15D). In response to the notifications, the packet generating circuits 111 to 114, the transmitting unit 117, and so on in the data transmitting device 100D resume the packet generating and transmitting (S31 and S32) under the control of the device control circuit 101. Similarly, the receiving unit 214, the packet processing units 216 to 219, and so on in the data receiving device 200D resume the packet receiving and processing (S36 and S37) under the control of the device control circuit 201. In this case, the notifications in S15D described above are issued in order to ensure that the packet transmitted as a result of the packet transmission resumption at the data transmitting device 100D does not arrive at the receiving unit 214 earlier than the resumption of the reception and processing performed by the data receiving device 200D. That is, the notification to the data receiving device 200D is issued earlier than the notification to the data transmitting device 100D. Under the control of the device control circuits 101 and 201, a total of N signal lines including the alternative signal line WS and the N−1 signal lines other than the failed signal line W3 are used to start transfer of data packets and control packets between the data transmitting device 100D and the data receiving device 200D, as in the case before the failure of the signal line W3.

When the timing at which the data transmitting device 100D resumes the packet generation and transmission and the timing at which the data receiving device 200D resumes the packet reception and processing are to be determined through signal monitoring, the following operation is performed. After receiving the notifications indicating the signal line switching due to the failure of the signal line W3, the notifications being issued from the signal-line selection instructing circuits 118A and 212A, the signal-line switching management circuit 310 exchanges signals with the device control circuit 101 in the data transmitting device 100D and the device control circuit 201 in the data receiving device 200D. As a result of the signal exchange, the signal-line switching management circuit 310 determines timing at which the data transmitting device 100D can resume the packet generation and transmission and the data receiving device 200D can resume the packet reception and processing through switching of the connection of the failed-signal line W3 to the alternative signal line WS. On the basis of the timing determination, the signal-line switching management circuit 310 issues transfer resumption notifications to the device control circuit 101 in the data transmitting device 100D and the device control circuit 201 in the data receiving device 200D (S15D). In response to the notifications, the packet generating circuits 111 to 114, the transmitting unit 117, and so on in the data transmitting device 100D resume the packet generation and transmission (S31 and S32) under the control of the device control circuit 101. Similarly, the receiving unit 214, the packet processing units 216 to 219, and so on in the data receiving device 200D resume the packet reception and processing (S36 and S37) under the control of the device control circuit 201. In this case, the notifications in S15D described above are issued in order to ensure that the packet transmitted as a result of the packet transmission resumption at the data transmitting device 100D does not arrive at the receiving unit 214 earlier than the resumption of the reception and processing performed by the data receiving device 200D. That is, the notification to the data receiving device 200D is issued earlier than the notification to the data transmitting device 100D. Under the control of the device control circuits 101 and 201, a total of N signal lines including the alternative signal line WS and the N−1 signal lines other than the failed signal line W3 are used to start transfer of data packets and control packets between the data transmitting device 100D and the data receiving device 200D, as in the case before the failure of the signal line W3.

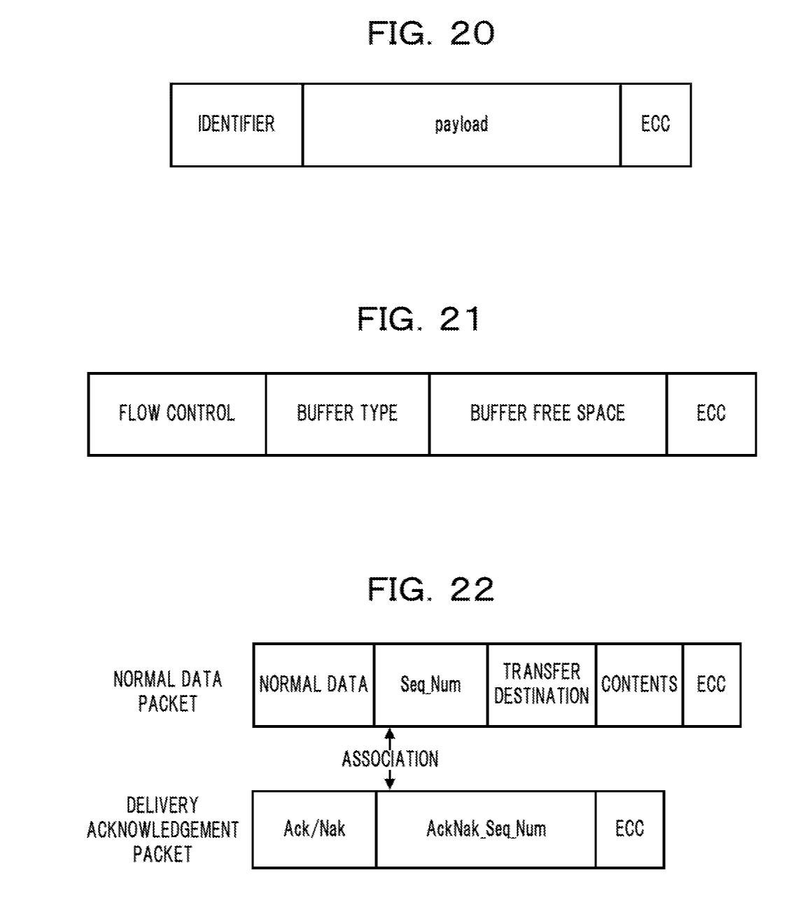

Various types of packet transferred between the data transmitting device and the data receiving device in the above described embodiment will now be described with reference to FIGS. 20 to 24.

FIG. 20 illustrates one example of the format of various types of packet. As illustrated in FIG. 20, a packet includes an “identifier” field, a “payload” field, and an “ECC” field.

The “identifier” field contains information representing a packet type. The “identifier” field contains, for example, information “0000” representing a normal data packet, “0001” representing a flow control packet, and “0010” representing an interrupt packet.

The “payload” field contains the contents of the packet. The length of the “payload” field varies depending on the packet type or length.

The “ECC” field contains an error check and correction code.

FIG. 21 illustrates an example the format of the flow control packet. The flow control packet is used to notify the data transmitting device about the free spaces of the buffers in the data receiving device during data transfer or during initialization. As a flow control system, e.g., as a system for managing the buffer free spaces, there are two systems: a bitwise or bytewise management system (which performs management for each bit or for each byte) and a credit-based management system (which manages multiple bytes as one credit).

As illustrated in FIG. 21, the flow control packet has a “flow control” field, a “buffer type” field, a “buffer free space” field, and an “ECC” field.

The “flow control” field contains information indicating that the packet is a flow control packet. The “buffer type” field contains information for identifying each buffer when multiple buffers are present. The “buffer free space” field contains information indicating a buffer free space in units of bits, bytes, credits, or the like. The “ECC” field contains an error check code.

A transmission acknowledgement packet will be described next. During transmission of a data packet, the data transmitting device attaches a sequence number to the data packet. In order to notify the data transmitting device whether or not the data packet is properly received by the data receiving device, the data receiving device sends, to the data transmitting device, a delivery acknowledgement packet to which the sequence number of a data packet that is properly received last time is attached.

There are two types of delivery acknowledgement packets: a packet for an affirmative response (Ack: Acknowledgement) indicating that the data packet is properly received and a packet for a negative response (Nack: No acknowledgement) indicating a retransmission request because of error. FIG. 22 illustrates an example of the format of the delivery acknowledgement packet in association with the format of a data packet. As illustrated in FIG. 22, the delivery acknowledgement packet includes an “Ack/Nak” field, an “AckNak_Seq_Num” field, and an “ECC” field. The “Ack/Nak” field contains information indicating the affirmative response (Ack) or the negative response (Nak). The “AckNak_Seq_Num” field contains information indicating the same number as the sequence number of a received data packet. The “ECC” field contains an error check code.

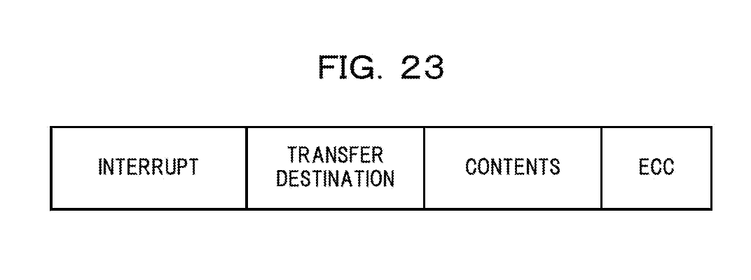

An interrupt packet will be described next. The interrupt packet is a control packet that is transferred by interrupting data-packet transfer upon an unexpected event, such as a failure. As illustrated in FIG. 23, the interrupt packet includes an “interrupt” field, a “transfer destination” field, a “contents” field, and an “ECC” field. The “interrupt” field contains information indicating that the packet is an interrupt packet. The “transfer destination” field contains information indicating the transfer destination of the packet. The “contents” field contains information indicating the contents of the event indicated by the packet. The “ECC” field contains an error check code.

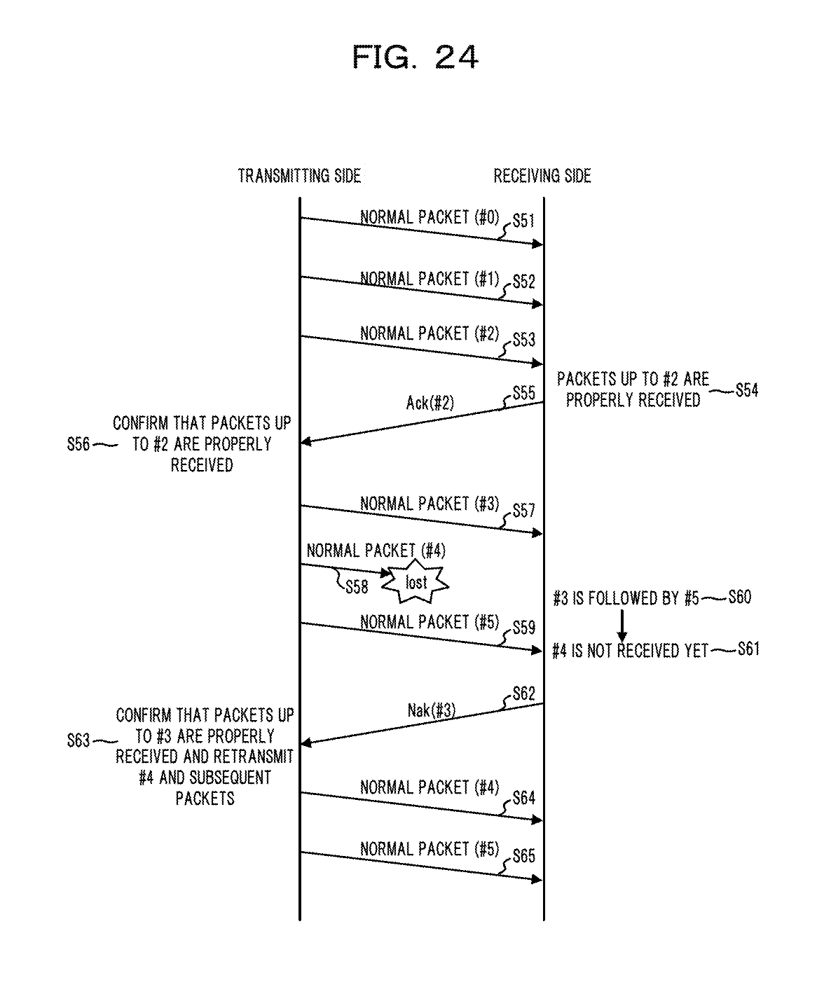

An example of an operation for the delivery acknowledgement packet will now be described with reference to FIG. 24.

In FIG. 24, when data packets are transferred (S51 to S53) and are properly received by the data receiving device (S54), the data receiving device transmits a delivery acknowledgement packet indicating the affirmative response to the data transmitting device (S55). It is assumed that data packets are continuously transferred in S57 to S59 and the packet transferred in S58 does not arrive at the data receiving device. The data receiving device detects that the packet has not arrived (S60 and S61) and sends the delivery acknowledgement packet indicating the negative response to the data transmitting device (S62). The data transmitting device checks the data packet that has not arrived (S63) and re-transmits the data packet and subsequent packets (S64 and S65).

Although a case in which one alternative signal line is provided has been described in the above embodiment, multiple alternative signal lines may also be provided according to a modification of the embodiment. In the modification, control packets can be transmitted/received through the multiple alternative signal lines. In this case, the control packet may be divided for transfer to the multiple alternative signal lines or a type of packet to be transferred to each of the alternative signal lines may be determined according to the type of control packet.

In the modification in which multiple alternative signal lines are provided, when a signal line failure occurs, control is performed so that a failed signal line or failed signal lines are sequentially replaced with the alternative signal line(s) in accordance with a failure of the signal line(s). Thus, at the point when all alternative signal lines are used to replace the failed signal lines, data packets and the control packets are transferred through the same signal lines, as described in the above embodiment with reference to, for example, FIG. 9.

All examples and conditional language recited herein are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A data transfer system transmitting and receiving data containing a data body and control data for reporting information related to control of the data body via a plurality of signal lines, the data transfer system comprising:
a data transmitting device including
a transmission-data selecting unit that selects a data body to be transmitted,
a transmitting unit that divides the selected data body and sends the divided data body to the plurality of signal lines,
an alternative-signal-line transmitting unit that sends the control data to an alternative signal line, the alternative signal line being an alternative to the plurality of signal lines, and
a transmission signal-line selecting unit that selectively connects the alternative signal line to one of an output terminal of the transmitting unit and an output terminal of the alternative-signal-line transmitting unit, the transmission selecting unit connects, when one of the plurality of signal lines fails, the alternative signal line to the output terminal of the transmitting unit instead of the failed signal line; and
a data receiving device including
a plurality of reception signal-line selecting units provided for the corresponding plurality of signal lines, each reception signal-line selecting unit selects a corresponding signal line for receiving the divided data body and the alternative signal line for receiving the control data from the data transmitting device,
a receiving unit that assembles the divided data body received through the reception signal-line selecting units,
a routing unit that routes the data received by the receiving unit,
an alternative-signal-line receiving unit that receives the control data received through the alternative signal line, and
a control-data selecting unit that selectively connects to one of the alternative-signal-line receiving unit and the routing unit.

2. The data transfer system according to claim 1, wherein, when one of the signal lines fails, the data transmitting device transmits an initial data to the data receiving device to start data transmission using the alternative signal line and the signal lines other than the failed signal line, and
the data receiving device recognizes the start of the data transmission upon receiving the initial data and receives the data through the alternative signal line and the signal lines other than the failed signal line.

3. The data transfer system according to claim 1, wherein, when one of the signal lines fails, the data transmitting device starts data transmission using the alternative signal line and the signal lines other than the failed signal line by using a timer to clock a time duration from when the signal line fails until the data transmission is restarted, and
the data receiving device recognizes the start of the data transmission by using the timer and receives the data through the alternative signal line and the signal lines other than the failed signal line.

4. The data transfer system according to claim 1, wherein, when one of the signal lines fails, the data transmitting device starts data transmission using the alternative signal line and the signal lines other than the failed signal line, in response to a notification from an external control device, and
the data receiving device recognizes the start of the data transmission in response to the notification and receives the data through the alternative signal line and the signal lines other than the failed signal line.

5. A data transmitting device transmitting data containing a data body and control data for reporting information related to control of the data body via a plurality of signal lines, the data transmitting device comprising:
a transmission-data selecting unit that selects a data body to be transmitted;
a transmitting unit that divides the selected data body and sends the divided data body to the plurality of signal lines;
an alternative-signal-line transmitting unit that sends the control data to an alternative signal line, the alternative signal line being an alternative to the plurality of signal lines; and a
a transmission signal-line selecting unit that selectively connects the alternative signal line to one of an output terminal of the transmitting unit and an output terminal of the alternative signal line transmitting unit, the transmission selecting unit connects, when one of the plurality of signal lines fails, the alternative signal line to the output terminal of the transmitting unit instead of the failed signal line.

6. The data transmitting device according to claim 5, wherein, when one of the signal lines fails, an initial data is transmitted to a data receiving device to start data transmission using the alternative signal line and the signal lines other than the failed signal line.

7. The data transmitting device according to claim 5, wherein, when one of the signal lines fails, data transmission using the alternative signal line and the signal lines other than the failed signal line is started by using a timer to clock a time duration from when the signal line fails until the data transmission is restarted.

8. The data transmitting device according to claim 5, wherein, when one of the signal lines fails, data transmission using the alternative signal line and the signal lines other than the failed signal line is started in response to a notification from an external control device.

9. A data receiving device receiving data from a data transmitting device, the data containing a data body and control data for reporting information related to control of the data body via a plurality of signal lines, the data receiving device comprising:
a plurality of reception signal-line selecting units provided for the corresponding plurality of signal lines, each reception signal-line selecting unit selectively connecting a corresponding signal line for receiving the divided data body and the alternative signal line for receiving the control data from a data transmitting device, when the corresponding signal lines fails, the reception signal-line selecting unit corresponding to the failed signal line connects to the alternative signal line;
a receiving unit that assembles the divided data body received through the reception signal-line selecting units;
a routing unit that routes the data received by the receiving unit;
an alternative-signal-line receiving unit that receives control data received through the alternative signal line; and
a control-data selecting unit that selectively connects to one of the alternative-signal-line receiving unit and the routing unit.

10. The data receiving device according to claim 9, wherein, when one of the signal lines fails, start of data transmission is recognized upon receipt of an initial data sent from the data transmitting device, and the data is received through the alternative signal line and the signal lines other than the failed signal line.

11. The data receiving device according to claim 9, wherein, when one of the signal lines fails, start of data transmission is recognized using a timer to clock a time duration from when the signal line fails until the data transmission is restarted, and the data is received through the alternative signal line and the signal lines other than the failed signal line.

12. The data receiving device according to claim 9, wherein, when one of the signal lines fails, start of data transmission is recognized in response to a notification from an external control device, and the data is received through the alternative signal line and the signal lines other than the failed signal line.

13. A data transfer method for transmitting data containing a data body and control data via a plurality of signal lines and an alternative signal line, the method comprising:
selecting the data body to be transmitted;
dividing the selected data body and sending the divided data to the plurality of signal lines;
obtaining control data that reports information related to the control of the divided data;
transmitting the divided data to a receiving device via the plurality of signal lines and the control data to the receiving device via the alternative signal line during normal operations; and
transmitting, when one of the plurality of signal lines fails, the divided data and the control data via the alternative signal line and the plurality of signal lines except for the failed signal line.

14. The data transfer method according to claim 13, further comprising:
selectively connecting corresponding ones of the plurality of signal lines and the alternative signal line;
receiving the divided data and the control data via the selectively connected corresponding ones of the plurality of signal lines and the alternative signal line;
assembling the divided data received through the plurality of signal lines selected in the selectively connecting;
routing the assembled data; and
receiving the control data through the alternative signal line during the normal operations;
wherein, when one of the plurality of signal lines fails, the alternative signal line is used as a replacement for the failed signal line and the divided data and the control data is received via the alternative signal line and the plurality of signal lines except for the failed signal line.

15. The data transfer method according to claim 13, further comprising:
transmitting, when one of the signal lines fails, an initial data to signal a start of data transmission using only the alternative signal line and the signal lines other than the failed signal line.

16. The data transfer method according to claim 13, further comprising:
starting a timer, when one of the signal lines fails, to clock a time duration from when the signal line fails until the data transmission is restarted,
upon restarting, the data is transmitted via only the alternative signal line and the signal lines other than the failed signal line.

17. The data transfer method according to claim 13, further comprising:
receiving, when one of the signal lines fails, a notification from an external control device and using only the alternative signal line and the signal lines other than the failed signal line to transmit the data.

18. The data transfer method according to claim 14, further comprising:
transmitting, when one of the signal lines fails, an initial data to signal a start of data transmission using only the alternative signal line and the signal lines other than the failed signal line; and
recognizing, on a side receiving the data, the initial data indicating the data is being transmitted via only the alternative signal line and the signal lines other than the failed signal line.

19. The data transfer method according to claim 14, further comprising:
starting a first timer, on a side transmitting the data, when one of the signal lines fails, to clock a time duration from when the signal line fails until the data transmission is restarted,
starting a second timer, on a side receiving the data, when the one of the signal lines fails, to clock the time duration from when the signal line fails until the data transmission is restarted,
upon restarting the data transmission, the data is transmitted and received through only the alternative signal line and the signal lines other than the failed signal line.

20. The data transfer method according to claim 14, further comprising:
receiving at both a side transmitting the data and a side receiving the data, when one of the signal lines fails, a notification from an external control device, and using only the alternative signal line and the signal lines other than the failed signal line to transmit and receive the data.
